(19) United States
(12) Patent Application Publication
(10) Pub. No.: US 2024/0217074 A1
(43) Pub. Date: Jul. 4, 2024

(54) Bidirectional Mechanical Converting Unit

(71) Applicants: HANGZHOU GREAT STAR INDUSTRIAL CO., LTD., Hangzhou City (CN); RATCHET SOLUTIONS, INC., Auburn, WA (US)

(72) Inventor: Weiyi Wang, Hangzhou City (CN)

(73) Assignees: HANGZHOU GREAT STAR INDUSTRIAL CO., LTD., Hangzhou City (CN); RATCHET SOLUTIONS, INC., Auburn, WA (US)

(21) Appl. No.: 18/219,818

(22) Filed: Jul. 10, 2023

Related U.S. Application Data
(63) Continuation-in-part of application No. 15/782,432, filed on Oct. 12, 2017, now Pat. No. RE49574.
Application No. 15/782,432 is a reissue of application No. 13/255,187, filed on Sep. 8, 2011, now Pat. No. 9,156,145.

(30) Foreign Application Priority Data
Jul. 7, 2011 (CN) 201110189889.9

(51) Int. Cl. B25B 15/04; B25B 13/46; B25G 1/08

(52) U.S. Cl. CPC B25B 15/04; B25G 1/085; B25B 13/465; B25B 13/467

(57) ABSTRACT

The present invention discloses a screwdriver comprising: a main shaft; a driving mechanism, the driving mechanism comprising a driving means and a reversing means, which are coupled to each other; and a handle for input of a torque. The handle engages with the driving means. By means of the driving means, regardless of a rotation direction of the rotation means, the torque is transmitted in a predetermined direction to the main shaft and output thereby. By means of the reversing means, the predetermined direction can be altered.

### RELATED APPLICATIONS

This application is a continuation-in-part (CIP) application claiming benefit of US Reissue application Ser. No. 15/782,432 filed on Oct. 12, 2017, which is a reissue application of U.S. Pat. No. 9,156,145 issued on Oct. 13, 2015, which was granted from U.S. patent application Ser. No. 13/255,187, which is a national phase application of PCT/CN2011/079246 filed on Sep. 1, 2011, which claims priority to Chinese Patent Application No. 201110189889.9 filed on Jul. 7, 2011, the disclosures of which are incorporated herein in their entirety by reference.

### FIELD OF THE INVENTION

The present invention relates to a manual tool, and more particularly, to a mechanical rectifier which efficiently utilizes the bidirectional rotations of a driving means.

### DESCRIPTION OF THE PRIOR ART

During the using of common manual tools such as screwdrivers and torque wrenches, there is a movement limitation of the human hand in rotation direction, namely the inability of the human hand to turn continuously in one direction. The operation of such a tool whose rotation axis of the handle is coaxial with the tool's main shaft consists of a repetition of the following cycle: first, the hand rotates the handle in the desirable direction (e.g., tightening or loosening a screw); second, the hand is rotated in the opposite direction to reposition the tool for next cycle. During the second portion of the above mentioned cycle, the hand's reversed rotation can be achieved by re-grasping the handle after released it, or by the tool which is equipped with a one-way means such as a ratchet to keep the main shaft stable during the reversed rotation of the handle, or by re-inserting the tool bit to the screw after extracted the bit from engagement with the screw. However, in any case, the hand's reversed rotation could not bring any effective advance of the fastener, and therefore it becomes a wasted movement.

U.S. Pat. No. 5,931,062 discloses a mechanical rectifier, which comprises a shaft; two driving elements mounted on the shaft, each having a one-way clutch interposed between it and the shaft, with the clutches oriented in the same way on the shaft so that the shaft is always entrained in only one direction of rotation when either one of the two driving elements is rotated in that direction, and the shaft is overrun by a driving element that is rotated in the opposite direction; a rotation means positioned along the axis of said shaft and engaging a selected one of said driving elements; and a reversing mechanism coupling the two driving elements together and forcing them to always rotate in opposite directions so that one driving element entrains the shaft and the other driving element overruns the shaft, thus causing the shaft to always turn in only one direction, regardless of the direction of rotation of the driving elements, so that transfers the bidirectional rotations of the rotation means (e.g., a handle) into the unidirectional rotation of the shaft. This mechanical rectifier can efficiently utilizes the rotations of the rotation means in either way, i.e., no matter the handle rotates clockwise or counterclockwise, the shaft rotates in a same direction, therefore it can improve the efficiency of hand motion, and save operation time.

However, the reversing mechanism of that invention can only make the shaft rotate in one direction. To meet the requirement of rotating the shaft in two ways (e.g., tightening or loosening a fastener in the application of a screwdriver), the handle of that invention must be able to be removed from the shaft which is coaxial with it, and the two ends of the shaft (assumed to be end A and end B) should be able to adapt with tool bits. Assuming end A is used to tighten a fastener in the beginning, in order to loosen this fastener, the handle mounted on end B of the shaft must be removed from the shaft, then people should re-mount the handle to end A of the shaft, insert a suitable tool bit on end B, and then start the fastener-loosening action. If the fastener to be loosened is the same type as the one being tightened in the beginning, the tool bit must be removed from end A before the handle re-mounting, and be inserted to end B. It is obvious that the direction-switching of the shaft is very inconvenient. It is even troublesome to replace the bit to the two ends of the shaft for multi-purpose screwdrivers with replaceable bits. Furthermore, it means the integrity of the whole screwdriver itself cannot be ensured and its parts are easy to get lost, to assure the handle can be removed from the shaft easily.

Therefore, it is desired to develop a dual-way mechanical rectifier which can switch the rotation direction of the shaft conveniently.

### SUMMARY OF THE INVENTION

In view of the above, the technical object of the present invention is to provide a dual-way mechanical rectifier which can switch the rotation direction of the main shaft conveniently.

For the above purpose, the present invention provides a dual-way mechanical rectifier, comprising: a main shaft; a driving mechanism, which includes a driving means and a reversing means which are coupled to each other; and a rotation means for inputting torque, a rotation axis of the rotation means being coaxial with the main shaft, the rotation means and the driving mechanism being coupled to each other, and the driving mechanism delivering the torque to output at the main shaft at a predetermined direction, no matter in which direction the rotation means rotates; wherein the predetermined direction can be switched via the reversing means.

Further, the driving means is sleeved on the reversing means; the driving means includes two driving elements mounted on the main shaft, each having a one-way clutch interposed between it and the main shaft, and a transmission structure coupling the two driving elements and forcing them to rotate in opposite directions; wherein the two driving elements are spaced apart axially; the reversing means includes the one-way clutches; both of the one-way clutches are oriented in a same way, so that the main shaft is entrained in one direction of rotation by one of the two driving elements which is rotating in the direction, and the main shaft is overrun by the other driving element which is rotating in the opposite direction.

In one embodiment of the dual-way mechanical rectifier of the present invention, the two driving elements are a capstan gear and a follower gear respectively; the transmission structure includes at least one idle gear axle perpendicular to the main shaft, at least one idle gear is disposed on the at least one idle gear axle and engaged with the capstan gear and the follower gear together, so that the capstan gear and the follower gear rotate in opposite directions; and the capstan gear is affixed with the rotation means. Further, the capstan gear, the follower gear and the idle gear are bevel gears. Even further, the transmission structure includes two idle gears axles perpendicular to the main shaft; two idle gears are disposed on the idle gear axles and engaged with the capstan gear and the follower gear together, so that the capstan gear and the follower gear rotate in opposite directions.

This embodiment can have multiple preferred technical schemes. In one scheme, the main shaft has at least one profiled surface, through which the reversing means engages with the main shaft. Further, the main shaft has a plurality of profiled surfaces. Even further, the main shaft has three profiled surfaces. In addition, the at least one profiled surface of the main shaft may be configured into two segments, which are corresponding to the two driving elements.

In this preferred scheme, the reversing means sleeved on the main shaft includes a reversing element and two sets of rolling elements; wherein the reversing element is sleeved on the main shaft coaxially in clearance fitting, two sets of slots are disposed on the reversing element for receiving the two sets of rolling elements, positions of which are corresponding to positions of the two driving elements; each one of the two driving elements has an inner circumference, through which the driving element is sleeved on the main shaft in clearance fitting; each set of the rolling elements includes at least one rolling element, which can roll on the profiled surface; the rolling element can be pushed with the two sets of slots of the reversing element to engage with the profiled surface and the inner circumference together; wherein the one-way clutch is formed through the rolling elements engaging with the profiled surface and the inner circumference together.

Further, the inner circumferences are cylindrical surfaces, the rolling elements are cylinder rolling needles, and the axes of the cylinder rolling needles are parallel to the axis of the main shaft. Or, the inner circumferences are frusto-conical surfaces, the rolling elements are conical rolling shafts, the profiles of the rolling shafts are matched with gaps between the profiled surface and the inner circumferences. Or, the inner circumferences are cylindrical surfaces or tori, the rolling elements are rolling balls.

Further, a radial gap is formed between the profiled surface and the inner circumference, wherein dimension of middle portion of the gap is bigger than diameters of the rolling elements, and dimensions of both end portion of the gap are smaller than the diameters of the rolling elements. Even further, the profiled surface is a cylindrical surface, an elliptic cylindrical surface, a paraboloid or a plane.

Further, number of the rolling elements within one set of the two sets of the slots of the reversing element equals to number of the profiled surface. Even further, number of the rolling elements within each set of the two sets of the slots of the reversing element equals to number of the profiled surface. Or, number of the rolling elements within one set of the two sets of the slots of the reversing element is more than number of the profiled surface. Or, number of the rolling elements within one set of the two sets of the slots of the reversing element is less than number of the profiled surface.

Further, the reversing element can be switched between two predetermined positions around circumference of the main shaft, to set rotation direction of the main shaft through changing position relationship between the profiled surface and the rolling elements.

In another preferred technical scheme of the dual-way mechanical rectifier of the present invention, two pawl seats are disposed on the main shaft on positions corresponding to the two driving elements; a pair of opposite swinging pawls are disposed on each of the pawl seat symmetrically; the two driving elements are provided at least partially annularly with a toothed inner circumference which can engage with at least one of the pawls; the reversing means is sleeved on the main shaft, and positioning of the pawls can be controlled, to set rotation direction of the main shaft through changing the positioning of the pawls.

Further, the reversing means includes a reversing element sleeved on the main shaft coaxially in clearance fitting; the reversing element have openings through which the pawls can engage with the toothed inner circumference; at least one end of the openings around circumference of the main shaft is used for pushing the pawls, to control the positioning of the pawls; wherein the one-way clutch is formed through the pawls engaging with the toothed inner circumference. Even further, the reversing element can be switched between two predetermined positions around circumference of the main shaft, to set rotation direction of the main shaft through changing the positioning of the pawls.

Further, an elastic element is disposed between each pair of the pawls to keep the pawls diverged against the toothed inner circumference.

Further, the toothed inner circumference is an inner ratchet circumference.

In yet another preferred technical scheme of the dual-way mechanical rectifier of the present invention, two sets of slots are disposed at positions on a circumference of the main shaft corresponding to positions of the two driving elements, each set of slots including two slots; a detent urged outwards by an elastic element is disposed in each slot, the two driving elements are provided with a toothed inner circumference which can engage with at least one of the detents; the reversing means is sleeved on the main shaft, and positioning of the detents can be controlled, to set rotation direction of the main shaft through changing the positioning of the detents.

Further, the reversing means includes a reversing element sleeved on the main shaft coaxially in clearance fitting; the reversing element have openings through which the detents can engage with the toothed inner circumference; at least one end of the openings around circumference of the main shaft is used for pushing the detents, to control the positioning of the detents; wherein the one-way clutch is formed through the detents engaging with the toothed inner circumference. Even further, the reversing element can be switched between two predetermined positions around circumference of the main shaft, to set rotation direction of the main shaft through changing the positioning of the detents.

Further, an out end of the detent is flat or includes an inclined surface matching with the toothed inner circumference.

In each of the preferred technical schemes of the dual-way mechanical rectifier of this embodiment, two orientation portions which correspond to the two positions of the reversing element are disposed on the reversing element, so as to set the rotation direction of the main shaft. Further, the two orientation portions on the reversing element includes two orientation slots for setting a clockwise or a counterclockwise rotation of the main shaft respectively, the main shaft includes an orientation ball supporting by a spring which can be positioned in either of the two orientation slots, so as to set the main shaft to rotate in clockwise or counterclockwise direction. Or, in each of the preferred technical schemes of the dual-way mechanical rectifier of this embodiment, further comprises: a push button assembly disposed on the main shaft which can slide along a direction parallel to the axis of the main shaft, but cannot rotate relative to the main shaft around circumference of the main shaft; a helical sliding slot disposed on the reversing element, wherein the push button assembly further slidably engages with the sliding slot, so as to convert a linear movement of the push button assembly along the direction parallel to the axis of the main shaft to a circular movement of the reversing element relative to the main shaft, so that the reversing element switches between the two positions to set the rotation direction of the main shaft. Further, may include a head cap affixed to the main shaft, a slideway is disposed on the head cap; the push button assembly is slidably disposed on the slideway.

In each of the preferred technical schemes of the dual-way mechanical rectifier of this embodiment, the transmission structure may include a transmission seat, on which the at least one idle gear axle is disposed perpendicular to the main shaft, the transmission seat is sleeved on the reversing element coaxially in clearance fitting; and the transmission seat is fastened to a mounting means. Even further, the mounting means is a holding ring or a supporting frame.

The dual-way mechanical rectifier of the present invention may include various other embodiments, for example:

The two driving elements are a first spur gear and a second spur gear; the transmission structure includes: a first axle and a second axle disposed parallel to and in a predetermined space-apart relationship with the shaft; a third spur gear and a fourth spur gear affixed on opposite ends of the first axle and the second axle respectively, so that the third spur gear intermeshes with the first spur gear and the fourth spur gear intermeshes with the second spur gear; and a fifth spur gear affixed to center of the first axle and a sixth spur gear affixed to center of the second axle, wherein the fifth spur gear intermeshes with the sixth spur gear.

Or, one of the driving elements is a first spur gear, the other of the driving elements is a first pulley; the transmission structure includes: an axle disposed parallel to and in a predetermined space-apart relationship with the shaft; a second spur gear and a second pulley affixed on opposite ends of the axle, the second spur gear intermeshes with the first spur gear on one side of the main shaft, and the second pulley is positioned for being driven by the first pulley via a belt; a belt coupling the first pulley with the second pulley.

Or, the two driving elements are a first pulley and a second pulley; the transmission structure includes: a first axle and a second axle which are disposed parallel to and in a predetermined space-apart relationship with the shaft; a third pulley and a fourth pulley affixed on opposite ends of the first axle and the second axle respectively, wherein the third pulley is positioned for being driven by the first spur gear and the fourth spur gear is positioned for being driven by the second spur gear; and a first spur gear affixed to center of the first axle and a second spur gear affixed to center of the second axle, wherein the first spur gear intermeshes with the second spur gear.

Or, the two driving elements are a first 3D pulley and a second 3D pulley; the transmission structure includes: an axle disposed in a plane perpendicular to and in a predetermined spatial relationship to the shaft; a third 3D pulley and a fourth 3D pulley which are mounted on opposite ends of the axle; and a 3D belt coupling the first, the second, the third and the fourth pulley.

The present invention also discloses a manual tool, which includes any one of above mentioned dual-way mechanical rectifier, wherein the rotation means is a handle, the main shaft rotates in a predetermined direction to output torque no matter in which direction the handle rotates, and the predetermined direction can be reversed. Further, a tool head is disposed on the main shaft to make the manual tool a screwdriver, a manual drill or a torque wrench. Even further, the tool head is a bit holder for a variety of tool bits.

The present invention also discloses a screwdriver, comprising:
a handle;
a main shaft;
a driving mechanism, one end of the main shaft fixedly coupled to the driving mechanism, one end of the handle fixedly coupled to the driving mechanism, wherein the driving mechanism comprises a driving means and a reversing means, which are coupled to each other, the driving means comprising a capstan gear, a follower gear, a transmission seat and at least one idle gear; the transmission seat provided thereon with at least one idle gear axle; the idle gear mounted on the respective idle gear axle, the idle gear cooperating with the capstan gear and the follower gear to serve for power transmission therebetween; wherein the handle used for input of a torque, one end of the capstan gear fixedly coupled to the handle, the handle configured to drive the capstan gear to rotate, the capstan gear driving the follower gear to rotate oppositely via the idle gear, wherein the reversing means comprises a reversing element, and, a first one-way clutch and a second one-way clutch which are mounted on the reversing element; the driving means sleeved on the reversing element; the first one-way clutch in engagement with the capstan gear, the second one-way clutch in engagement with the follower gear; one end of the reversing element fixedly coupled to the main shaft, the reversing element configured to drive the main shaft to rotate therewith; as a result of the torque input from the handle, one of the capstan gear and the follower gear driving the reversing element and the main shaft to rotate in a predetermined direction; wherein regardless of the torque input from the handle in the same or opposite direction to the predetermined direction, the main shaft always rotate in the predetermined direction;
wherein the reversing means is configured to be able to alter the predetermined direction.

Further, the capstan gear, the follower gear and the idle gear are all bevel gears.

Further, the capstan gear is provided on its inner surface with a ratchet circumference; the follower gear is provided on its inner surface with a ratchet circumference; the reversing element is provided therein with a first pawl compartment and a second pawl compartment; the first one-way clutch comprises two swinging pawls provided in the first pawl compartment; the ratchet circumference of the follower gear is configured to intermesh with at least one of the two pawls in the first pawl compartment; the second one-way clutch comprises two swinging pawls provided in the second pawl compartment; the ratchet circumference of the capstan gear is configured to intermesh with at least one of the two pawls in the second pawl compartment.

Further, the two pawls in the first pawl compartment are respectively formed on a first pawl member and a second pawl member; the two pawls in the second pawl compartment are respectively formed on a third pawl member and a fourth pawl member.

Further, the first pawl member and the third pawl member are sleeved on a first auxiliary shaft and configured to swing about the first auxiliary shaft; the second pawl member and the fourth pawl member are sleeved on a second auxiliary shaft and configured to swing about the second auxiliary shaft; the first auxiliary shaft and the second auxiliary shaft are mounted on the reversing element.

Further, a first elastic element is provided between the first pawl member and the second pawl member; a second elastic element is provided between the third pawl member and the fourth pawl member.

Further, the reversing means further comprises a reversing pin and a chuck, the reversing element provided therein a bore for receiving the reversing pin, the reversing pin disposed in the bore, the chuck coupled to the reversing pin, the chuck configured to be driven by an external force to drive the reversing pin to move therewith, wherein when the reversing pin moves to a first position, the pawl on the first pawl member protrudes out of the first pawl compartment and intermeshes with the ratchet circumference of the follower gear, and the pawl on the third pawl member protrudes out of the second pawl compartment and intermeshes with the ratchet circumference of the capstan gear; when the reversing pin moves to a second position, the pawl on the second pawl member protrudes out of the first pawl compartment and intermeshes with the ratchet circumference of the follower gear, and the pawl on the fourth pawl member protrudes out of the second pawl compartment and intermeshes with the ratchet circumference of the capstan gear.

Further, the chuck is sleeved on the reversing element; the reversing element is provided with a transverse slot in its side wall corresponding to the chuck; the chuck is coupled to the reversing pin by a coupling member.

Further, the coupling member is a pin passing through the transverse slot, one end of the pin coupled to the reversing pin, the other end coupled to the chuck; the chuck is configured to drive the reversing pin to move along its axis;
the reversing pin is provided, along its lengthwise direction, with first studs on one side and second studs on the opposing side; when the reversing pin moves to the first position, the second studs come in contact with the second pawl member and the fourth pawl member; when the reversing pin moves to the second position, the first studs come in contact with the first pawl member and the third pawl member.

Further, the two pawls in the first pawl compartment are formed on opposing sides of a first pawl member; the two pawls in the second pawl compartment are formed on opposing sides of a second pawl member.

Further, the first pawl member and the second pawl member are sleeved on an auxiliary shaft and configured to swing about the auxiliary shaft.

Further, the reversing means further comprises a reversing pin and a chuck, the reversing element provided therein a bore for receiving the reversing pin, the reversing pin disposed in the bore, the chuck coupled to the reversing pin, the chuck configured to be driven by an external force to drive the reversing pin to move therewith, wherein when the reversing pin moves to a first position, the reversing pin drives the first pawl member and the second pawl member to swing about the auxiliary shaft, causing the pawl on one side of the first pawl member to protrude out of the first pawl compartment and intermesh with the ratchet circumference of the follower gear and causing the pawl on the same side of the second pawl member as the first pawl member to protrude out of the second pawl compartment and intermesh with the ratchet circumference of the capstan gear; when the reversing pin moves to a second position, the reversing pin drives the first pawl member and the second pawl member to swing about the auxiliary shaft, causing the pawl on the other side of the first pawl member to protrude out of the first pawl compartment and intermesh with the ratchet circumference of the follower gear and causing the pawl on the same side of the second pawl member as the first pawl member to protrude out of the second pawl compartment and intermesh with the ratchet circumference of the capstan gear.

Further, the reversing pin is provided therein with holes respectively corresponding to the first pawl member and the second pawl member, the holes provided therein with push-out components configured to come in contact with the first pawl member and the second pawl member.

Further, the push-out components are balls, cylinders or ball-ended plungers.

Further, the screwdriver further comprises a holding ring, the holding ring sleeved on the driving means, the holding ring fixedly coupled to the transmission seat.

Further, the handle defines a second bore having an opening at an end of the handle away from the driving means; an end cover for closing the second bore is disposed at the opening; the second bore is configured to be used to accommodate spare bits.

The dual-way mechanical rectifier of the present invention combines the function of one-way clutches and the function of a reverser together on a reversing means, with a compact and simple structure. It not only can efficiently utilizes the movements of the rotation means in either way, but also can switch the rotation direction of the output shaft conveniently upon demand, with easy operations. The whole product is an integral design of which parts are not easy to get lost. When a push button is provided, operator can push with only one finger and ease the direction-switching of the output shaft greatly.

The present invention will be described in detail hereinafter in combination with the attached drawings and embodiments for better understanding the purpose, features and effects of the present invention.

### BRIEF DESCRIPTION OF THE DRAWINGS

FIG. 1 is a front elevational view of a first embodiment of the present invention in a first working state;

FIG. 2 is a sectional view along E-E of the embodiment in FIG. 1;

FIG. 3 is a front elevational view of the first embodiment of the present invention in a second working state;

FIG. 4 shows the assembly of the driving mechanism of the first embodiment of the present invention;

FIG. 5 is an exploded view of the driving mechanism in FIG. 4, wherein the driving means is removed from the reversing means;

FIG. 6 is an exploded view of the driving means in FIG. 5;

FIG. 7 is an exploded view of the reversing means in FIG. 5;

FIG. 8A is a sectional view along A-A in FIG. 1;

FIG. 8B is a sectional view along B-B in FIG. 1;

FIG. 8C is a partial sectional view along C-C in FIG. 2 with simplified components;

FIG. 8D is a partial sectional view along D-D in FIG. 2 with simplified components;

FIG. 9A is a sectional view along A′-A′ in FIG. 3;

FIG. 9C is a partial sectional view along C-C in FIG. 3 with simplified components;

FIG. 9D is a partial sectional view along D-D in FIG. 3 with simplified components;

FIG. 10 is a partial sectional view shows the engagement between the main shaft and the capstan gear or the follower gear in the first embodiment of the present invention;

FIG. 11C is a sectional view of the reversing means corresponding to the follower gear in a second embodiment of the present invention in a first working state, the sectioning position refers to C-C in FIG. 2 or 3 as a reference;

FIG. 11D is a sectional view of the reversing means corresponding to the capstan gear in the second embodiment of the present invention in the first working state, the sectioning position refers to D-D in FIG. 2 or 3 as a reference;

FIG. 12C is a sectional view of the reversing means corresponding to the follower gear in the second embodiment of the present invention in a second working state, the sectioning position refer to C-C in FIG. 2 or 3 as a reference;

FIG. 12D is a sectional view of the reversing means corresponding to the capstan gear in the second embodiment of the present invention in the second working state, the sectioning position refers to D-D in FIG. 2 or 3 as a reference;

FIG. 13C is a sectional view of the reversing means corresponding to the follower gear in a third embodiment of the present invention in a first working state, the sectioning position refers to C-C in FIG. 2 or 3 as a reference;

FIG. 13D is a sectional view of the reversing means corresponding to the capstan gear in the third embodiment of the present invention in the first working state, the sectioning position refers to D-D in FIG. 2 or 3 as a reference;

FIG. 14C is a sectional view of the reversing means corresponding to the follower gear in the third embodiment of the present invention in a second working state, the sectioning position refers to C-C in FIG. 2 or 3 as a reference;

FIG. 14D is a sectional view of the reversing means corresponding to the capstan gear in the third embodiment of the present invention in the second working state, the sectioning position refers to D-D in FIG. 2 or 3 as a reference;

FIG. 15 is a partial sectional view shows the structural relationship of the main shaft, the detents, the reversing element and the capstan gear, in a fourth embodiment of the present invention;

FIG. 16 is a partial sectional view shows the structural relationship of the main shaft, the detents, the reversing element and the capstan gear, in a fifth embodiment of the present invention;

FIG. 17 is a front elevational view of a sixth embodiment of the present invention;

FIG. 17A is a sectional view along A″-A″ of the embodiment in FIG. 17;

FIG. 17B is a sectional view along B′-B′ of the embodiment in FIG. 17;

FIG. 17C is a sectional view along C′-C′ of the embodiment in FIG. 17;

FIG. 17D is a sectional view along D′-D′ of the embodiment in FIG. 17;

FIG. 17E is a sectional view along E′-E′ of the embodiment in FIG. 17;

FIG. 18 is a schematic overview of a seventh embodiment;

FIG. 19 is a schematic view of FIG. 18 taken from another angle;

FIG. 20 is a schematic exploded partial view of FIG. 18;

FIG. 21 is a schematic structural view of the seventh embodiment after a handle and a holding ring are removed;

FIG. 22 is a schematic structural view of a driving mechanism in the seventh embodiment;

FIG. 23 is a schematic exploded view of the driving mechanism in the seventh embodiment;

FIG. 24 is a cross-sectional view of FIG. 19 taken along I-I;

FIG. 25 shows cross-sectional view of FIG. 24 taken along II-II and III-III;

FIG. 26 is a schematic exploded partial view of a reversing means in the seventh embodiment, showing how a chuck is coupled to a reversing element and a reversing pin;

FIG. 27 is a schematic exploded view of the reversing means in the seventh embodiment;

FIG. 28 is a front elevational view of the driving mechanism in the seventh embodiment;

FIG. 29 is a left side view of FIG. 28;

FIG. 30 is a cross-sectional view of FIG. 28 taken along IV-IV;

FIG. 31 is a cross-sectional view of FIG. 29 taken along V-V;

FIG. 32 is a schematic structural view of a pawl member in an eighth embodiment;

FIG. 33 is a schematic exploded view of a reversing means in the eighth embodiment;

FIG. 34 is a schematic exploded view of the reversing means in the eighth embodiment;

FIG. 35 schematically illustrates how the reversing means in the eighth embodiment operates;

FIG. 36 is a schematic illustration of a push-out component in the eighth embodiment, which is implemented as a ball-ended plunger.

### DETAILED DESCRIPTION OF THE PREFERRED EMBODIMENTS

### Embodiment I

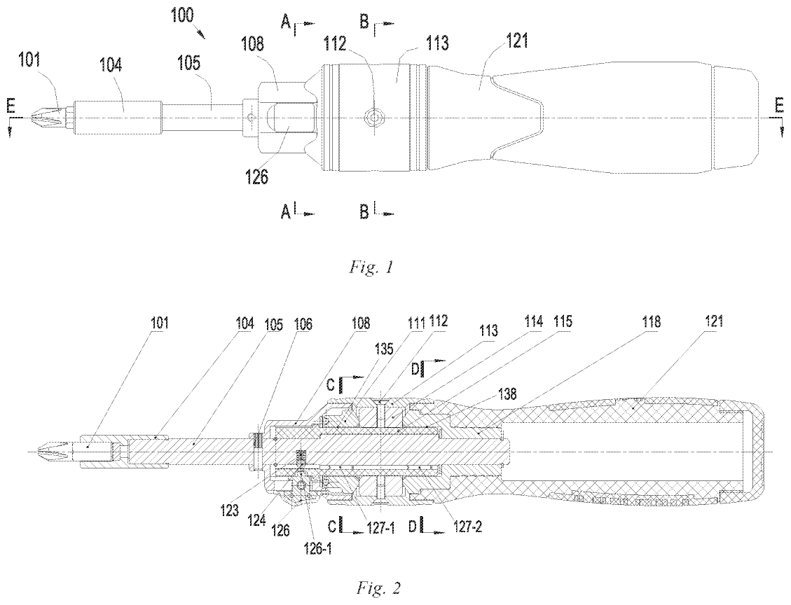

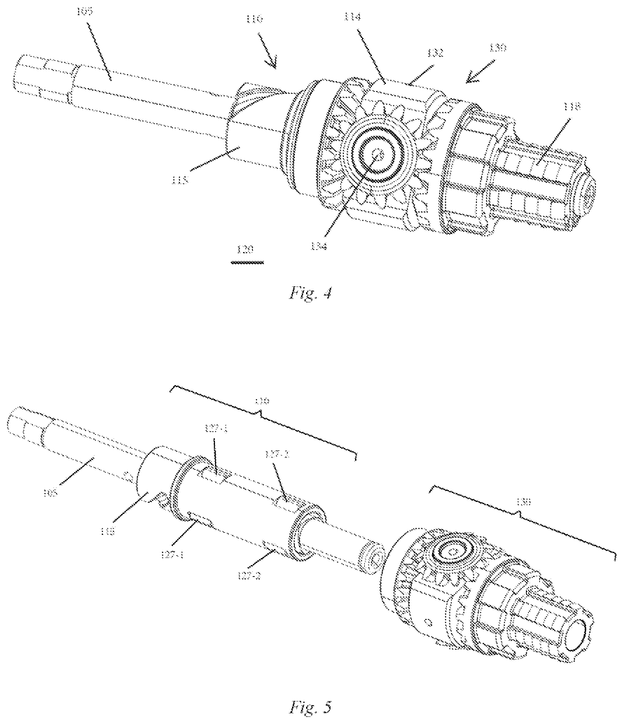

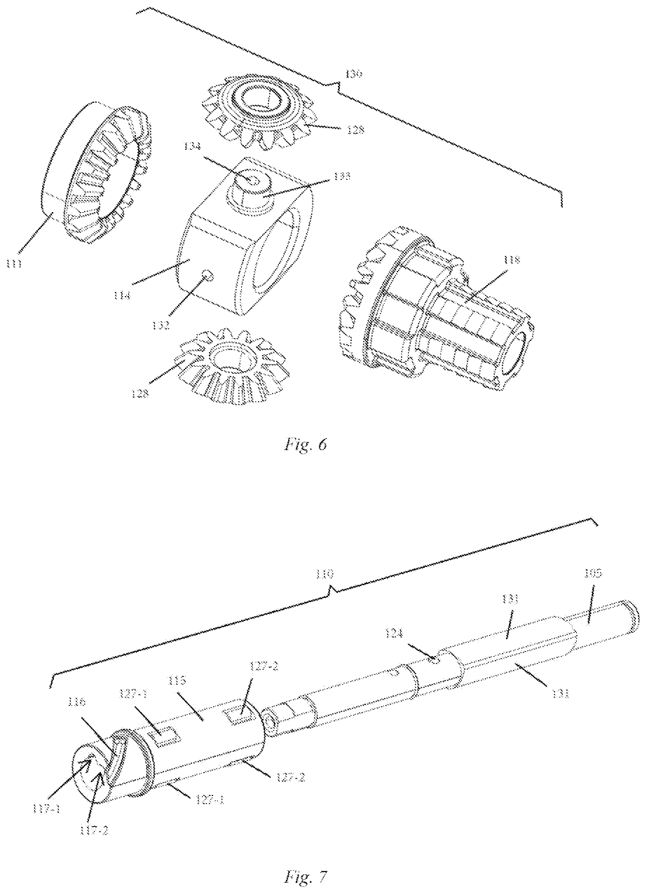

Referring to FIGS. 1 and 2, a preferred embodiment is a manual screwdriver 100 utilizing the dual-way mechanical rectifier of the present invention, which achieves bidirectional double-speed power transmission through a driving mechanism 120 as shown in FIG. 4. The driving mechanism 120 includes a driving means 130 and a reversing means 110 as shown in FIG. 4, for realizing the rotation direction switching of the main shaft. FIGS. 5 and 6 illustrate the structural and assembly relationship between the driving means 130 and the reversing means 110. “Double-speeded driving at dual-way” or “dual-way transmission” in the present invention is in connection with the input, in other words, the input force of the handle, which acts as a rotation means, may be in either direction of clockwise or counterclockwise, and the input force at either direction can be utilized effectively. And the “direction switching” in the present invention is in connection with the output rotation direction of the main shaft can be selected to be one of clockwise or counterclockwise, upon demand. The clockwise or counterclockwise direction in the present invention is defined as the rotation direction observed along the axis from the bit to the handle.

The structure, operation and principle of the manual screwdriver 100 in this embodiment are described as follows.

### 1. Overall Structure of Screwdriver 100

Screwdriver 100 comprises a main shaft 105, a driving mechanism 120 and a rotation means. In this embodiment, the rotation means is a handle 121, on which the torque input at either direction (either clockwise or counterclockwise) is delivered to the main shaft 105 through the driving mechanism 120, so that the main shaft 105 outputs torque at a predetermined direction (clockwise or counterclockwise). The driving mechanism 120 is mounted on the main shaft 105, to deliver the driving torque of the handle 121 to the main shaft 105. A variety of tool bits 101 can be installed on the main shaft 105 via a bit holder 104 on the main shaft 105, for outputting torque.

Observing externally, the screwdriver 100 further includes a head cap 108 and a holding ring 113.

The head cap 108 is fixed on the main shaft 105 with a pin 106, so that the head cap 108 rotates together with the main shaft 105.

The holding ring 113 and the handle 121 are grasped with the two hands of an operator respectively, wherein the holding ring 113 keeps stable when it is grasped, and the handle 121 can be rotated in either direction (clockwise or counterclockwise) relative to the holding ring 113. The stable holding ring 113 is the basis for rotations of each component of the screwdriver 100.

### 2. Driving Mechanism 120

As shown in FIGS. 4 and 5, the driving mechanism 120 includes the driving means 130 and the reversing means 110, for realizing the bidirectional double-speed power transmission while the main shaft direction can be switched. The driving means 130 is sleeved on the outside of the reversing means 110, and the reversing means 110 is sleeved on the outside of the main shaft 105. The reversing means 110 plays with two functions: i) engaging with the driving means 130 to convert the bidirectional input into unidirectional output (i.e., the function of one-way clutches); and ii) switching the output direction (i.e., the function of a reverser).

2.1. Structure of the Driving Means 130. As shown in FIG. 6, the driving means 130 includes 4 bevel gears which includes a capstan gear 118, a follower gear 111, and two idle gears 128 which engage with the capstan gear and the follower gear together, and a transmission seat 114. It makes the driving being balanced to use two idle gears. It is also workable to use only one idle gear and does not affect the implementation of the present invention; therefore this invention does not restrict it. The capstan gear 118 is fixed with the handle 121 to deliver the torque input from the handle.

The capstan gear 118, the transmission seat 114 and the follower gear 111 are sleeved on the reversing element 115 of the reversing means 110 coaxially in clearance fitting in sequence, wherein the reversing means 110 forms the one-way clutch relationships of the capstan gear 118 and the follower gear 111 with the main shaft 105 respectively, namely, at one direction, the capstan gear entrains the main shaft while the follower gear overruns the main shaft; at the other direction, the function of the capstan gear and the follower gear is exchanged, the follower gear which was overrunning entrains the main shaft, while the capstan overruns the main shaft. Detailed implementation of the one-way clutch relationships will be further described in following section 2.2 and 2.3.

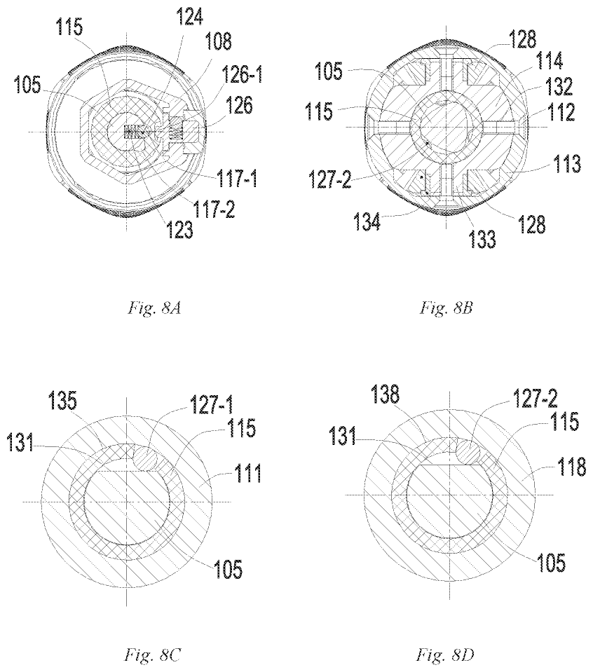

FIG. 8B shows the coupling relationship of the transmission seat 114, the reversing element 115 and the holding ring 113. The transmission seat 114 can rotate relative to the reversing element 115. The transmission seat 114 is provided with two idle gears axles 133 radially, for mounting of the idle gears 128. The idle gears 128 force the capstan gear 118 and the follower gear 111 always rotate in opposite directions, namely, when the capstan gear rotates clockwise, the follower gear rotates counterclockwise; vice versa, the follower gear rotates clockwise while the capstan gear rotates counterclockwise.

The transmission seat 114 further includes radial threaded holes 132 for fixing the holding ring 113. The holding ring 113 is fixed on the transmission seat 114 with screws 112. In this embodiment, threaded holes 134 are also provided axially on the idle gear axles 133. To have a compact structure, the threaded holes 134 may also be used to fix the holding ring 113, while the holding ring 113 further has the function of containing the axial displacement of the idle gears 128. Of course, the holding ring 113 of the present invention can be fixed on the transmission seat 114 through the threaded holes 132 only, and at the mean time, axial stoppers are provided through the threaded holes 134, or retaining elements such as retainer rings are provided on the idle gear axles, to contain the axial displacement of the idle gears 128.

### 2.2. Structure and Principle of the Reversing Means 110

As shown in FIG. 5, the reversing means 110 is sleeved on the main shaft 105, and the outside of the reversing means 110 is sleeved with the driving means 130. The reversing means 110 includes a reversing element 115 and two sets of rolling needles 127-1 and 127-2. The reversing element 115 is sleeved on the main shaft 105 coaxially in clearance fitting. Two sets of slots of which dimensions are bigger than the rolling needles 127-1 and 127-2, to receive the rolling needles 127-1 and 127-2, and allow the rolling needles 127-1 and 127-2 rolling freely. Axes of the rolling needles 127-1 and 127-2 are parallel to the axis of the main shaft 105. Referring to FIG. 2, the two sets of slots and rolling needles 127-1 and 127-2 are corresponding to the positions of the capstan gear 118 and the follower gear 111 of the driving means 130 respectively, namely, the first set of slots and rolling needles 127-2 engage with the inner circumference 138 of the capstan gear 118, and the second set of slots and rolling needles 127-1 engage with the inner circumference 135 of the follower gear 111. The inner circumferences of this embodiment are cylindrical surfaces.

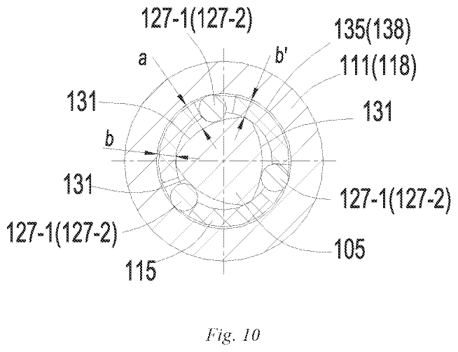

As shown in FIGS. 7 and 10, profiled surfaces 131 are disposed on the main shaft 105 at positions corresponding to the slots and rolling needles. In this embodiment, three profiled surfaces 131 are disposed on the main shaft 105, corresponding to three rolling needles 127-1 or 127-2 in each set, and the rolling needles 127-1 and 127-2 can roll on the profiled surfaces 131. In fact, there are two segments of working face on each profiled surface 131, which engage with the inner circumference 135 and the inner circumference 138 through the rolling needles 127-1 and 127-2 respectively.

The working face of the profiled surface 131 may be a cylindrical surface, an elliptic cylindrical surface, a paraboloid or other curved surface, also may be a plane, in other words, the contour line of the transect of the profiled surface 131 may be an arc, an elliptic arc, a parabola or other curve, also may be a straight line. A radial gap is formed between the profiled surface 131 and the inner circumference 135 or the inner circumference 138 (see the engagement relationship between the main shaft 105 and the capstan gear 138 or the follower gear 111 shown in FIG. 10), to contain the movement of the rolling needles therein. As long as around circumference of the main shaft, the dimension a of the middle portion of the radial gap is bigger than the diameters of the rolling needles 127-1, 127-2, and the dimensions b, b′ of the end portions are smaller than the diameters of the rolling needles 127-1, 127-2, the rolling needles can be pushed by the reversing element 115 to move between the two ends of the radial gap, and meet the self-locking condition at the engagement positions of the rolling needles with the profiled surfaces and the inner circumferences, the purpose of the present invention can be realized. The radial gap is not necessary to be symmetrical, namely, it does not affect the purpose of the present invention if b is not equal to b′.

In other embodiments, the number of the profiled surfaces can be one, two or more than three, which is also workable for the purpose of the present invention; therefore this invention does not restrict it. Accordingly, the number of rolling needles in each set can be one, two or more than three, and it is even workable if the number of the rolling needles is less or more than the number of the profiled surfaces. For example, total 6 slots in two sets are disposed on the reversing element 115 in this embodiment, for rolling needles 127-1 and 127-2. Even several slots receive no rolling needles, as long as assuring at least one rolling needle existing in each set of slots, the purpose of the present invention can be realized. If two rolling needles are disposed in one slot, no matter they are arranged side-by-side or head-by-end, the purpose of the present invention still can be realized.

In summary, as long as the capstan gear and the follower gear of the driving means 130 are engaged with the profiled surface through the rolling needles respectively, the purpose of the present invention can be realized, and this invention does not restrict it.

The rolling needles of the present invention can alternatively be replaced with other rolling elements, such as rolling balls, conical rolling shafts, etc., and at the mean time the corresponding configuration of the profiled surfaces and the inner circumferences are matched with the shape of the rolling elements, for example, the profiled surfaces and the inner circumferences are configured as tori or frusto-conical surfaces. Of course, each of the profiled surfaces may be machined into two segments corresponding to the two sets of rolling needles 127-1 and 127-2, and the purpose of the present invention also can be realized. The inner circumference 135 and the inner circumference 138 of this embodiment are of the same diameter, if they are of different diameters, as long as suitable sized rolling needles are selected to engage with the corresponding profiled surfaces, the purpose of the present invention still can be realized.

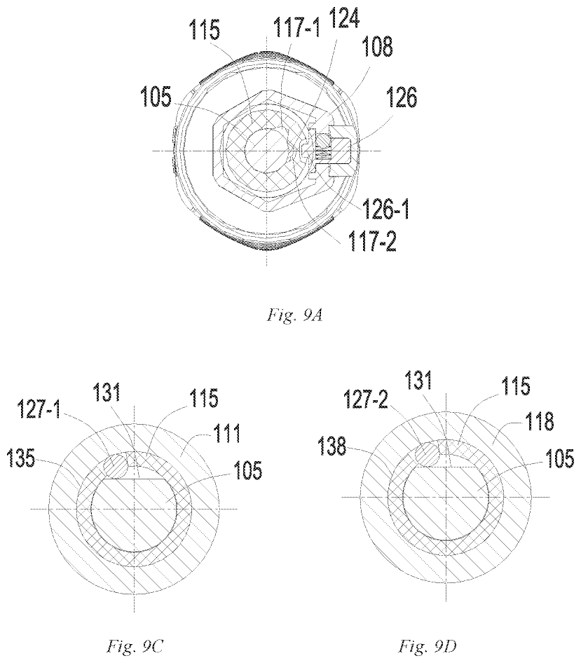

Incorporating FIGS. 8A, 8C, 8D and FIGS. 9A, 9C and 9D, the working principle of the reversing means 110 as one-way clutches and a reverser in two working states is explained hereinafter. The reversing means 110 is simplified into a structure with one rolling needle engaging with one planar profiled surface of the main shaft 105 in the figures.

FIGS. 8C and 8D corresponds the first working state of this embodiment, wherein the rolling needles 127-1 and 127-2 are pushed towards the right side in the figures with the reversing element 115. In FIG. 8C, the rolling needle 127-1 contacts the inner circumference 135 of the follower gear 111 and the profiled surface 131 at the same time, and in FIG. 8D, the rolling needle 127-2 contacts the inner circumference 138 of the capstan gear 118 and the profiled surface 131 at the same time.

When the capstan gear 118 rotates clockwise, the inner circumference 138 entrains the rolling needle 127-2 to rotate clockwise, and the rolling needle 127-2 receives friction rightwards on the profiled surface 131, i.e., the forces on the rolling needle 127-2 applied by the inner circumference 138 and the profiled surface 131 are both rightwards, so that the rolling needle 127-2 is clamped tightly by the wedge formed with the inner circumference 138 and the profiled surface 131, to entrain the main shaft 105 to rotate clockwise. At this moment, the follower gear 111 rotates counterclockwise, the rolling needle 127-1 engaging with the inner circumference 135 rotates counterclockwise as well, and this rolling needle receives friction leftwards on the profiled surface 131, i.e., the forces on the rolling needle 127-1 applied by the inner circumference 135 and the profiled surface 131 are both leftwards, because the dimension of the radial gap at the left side of the rolling needle is bigger than the diameter of the rolling needle, the rolling needle 127-1 is in a loosed state, correspondingly, the follower gear 111 overruns the main shaft 105.

When the capstan gear 118 rotates counterclockwise, the inner circumference 138 entrains the rolling needle 127-2 to rotate counterclockwise, the rolling needle 127-2 receives friction leftwards on the profiled surface 131, i.e., the forces on the rolling needle 127-2 applied by the inner circumference 138 and the profiled surface 131 are both leftwards, because the dimension of the radial gap at the left side of the rolling needle 127-2 is bigger than the diameter of the rolling needle, the rolling needle 127-2 is in a loosed state, therefore, the capstan gear 118 overruns the main shaft 105.

However, because of the existing of the idle gears 128, the follower gear 111 rotates clockwise. The inner circumference 135 entrains the corresponding rolling needle 127-1 to rotate clockwise, and the rolling needle 127-1 receives friction rightwards on the profiled surface 131, i.e., the forces on the rolling needle 127-1 applied by the inner circumference 135 and the profiled surface 131 are both rightwards, so that the rolling needle 127-1 is clamped tightly by the wedge formed with the inner circumference 135 and the profiled surface 131, to entrain the main shaft 105 to rotate clockwise.

Thus it can be seen, no matter the handle drives the capstan gear to rotate clockwise or counterclockwise, the main shaft 105 rotates clockwise in the first working state.

FIGS. 9C and 9D corresponds the second working state of this embodiment, wherein the rolling needles 127-1 and 127-2 are pushed towards the left side in the figures with the reversing element 115. In FIG. 9C, the rolling needle 127-1 contacts the inner circumference 135 of the follower gear 111 and the profiled surface 131 at the same time, and in FIG. 9D, the rolling needle 127-2 contacts the inner circumference 138 of the capstan gear 118 and the profiled surface 131 at the same time.

When the capstan gear 118 rotates clockwise, the inner circumference 138 entrains the rolling needle 127-2 to rotate clockwise, the rolling needle 127-2 receives friction rightwards on the profiled surface 131, i.e., the forces on the rolling needle 127-2 applied by the inner circumference 138 and the profiled surface 131 are both rightwards, because the dimension of the radial gap at the right side of the rolling needle 127-2 is bigger than the diameter of the rolling needle, the rolling needle 127-2 is in a loosed state, therefore, the capstan gear 118 overruns the main shaft 105.

However, because of the existing of the idle gears 128, the follower gear 111 rotates counterclockwise. The inner circumference 135 entrains the corresponding rolling needle 127-1 to rotate counterclockwise, and the rolling needle 127-1 receives friction leftwards on the profiled surface 131, i.e., the forces on the rolling needle 127-1 applied by the inner circumference 135 and the profiled surface 131 are both leftwards, so that the rolling needle 127-1 is clamped tightly by the wedge formed with the inner circumference 135 and the profiled surface 131, to entrain the main shaft 105 to rotate counterclockwise.

When the capstan gear 118 rotates counterclockwise, the inner circumference 138 entrains the rolling needle 127-2 to rotate counterclockwise, and the rolling needle 127-2 receives friction leftwards on the profiled surface 131, i.e., the forces on the rolling needle 127-2 applied by the inner circumference 138 and the profiled surface 131 are both leftwards, so that the rolling needle 127-2 is clamped tightly by the wedge formed with the inner circumference 138 and the profiled surface 131, to entrain the main shaft 105 to rotate counterclockwise. At this moment, the follower gear 111 rotates clockwise, the rolling needle 127-1 engaging with the inner circumference 135 rotates clockwise as well, and this rolling needle receives friction rightwards on the profiled surface 131, i.e., the forces on the rolling needle 127-1 applied by the inner circumference 135 and the profiled surface 131 are both rightwards, because the dimension of the radial gap at the right side of the rolling needle is bigger than the diameter of the rolling needle, the rolling needle 127-1 is in a loosed state, correspondingly, the follower gear 111 overruns the main shaft 105.

Thus it can be seen, no matter the handle drives the capstan gear to rotate clockwise or counterclockwise, the main shaft 105 rotates counterclockwise in the second working state.

In sum, the reversing means realized the function of one-way clutches in two working states respectively.

Refer to FIGS. 7, 8A and 9A, two orientation slots 117-1 and 117-2 are disposed on the reversing element 115, to engage with an orientation steel ball 124 disposed on the main shaft 105 for switching between the above mentioned two working states. The orientation steel ball 124 is urged by a spring 123 within the main shaft 105 into one of the orientation slots, for setting the reversing means 110 at one of the two working states. By rotating the reversing element 115 relative to the main shaft 115 for an angle, the positions of the orientation steel ball 124 in the two orientation slots can be switched, so that this embodiment can be switched between the above mentioned first working state and the second working state, and the function of a reverser of the reversing means 110 can be realized.

2.3. Operation Mode of this Embodiment is Explained as Follows Incorporating the Figures

2.3.1 Firstly, rotate the reversing element 115 relative to the main shaft 105, to position the orientation steel ball 124 in the desired one of the two orientation slots, such as in the orientation slot 117-1 shown in FIG. 8A, then the main shaft 105 is set to be able to rotate clockwise only, and this embodiment is in the above mentioned first working state.

2.3.1.1 Operator grasps the holding ring 113 with one hand, and rotates the handle 121 clockwise with another hand, to drive the capstan gear 118 rotating clockwise. At this moment, the rolling needle 127-2 corresponding to the capstan 118 is clamped tightly by the inner circumference 138 of the capstan gear 118 and the profiled surface 131 of the main shaft 105, to entrain the main shaft to rotate clockwise. The idle gears 128 force the follower gear 111 to rotate counterclockwise, the rolling needles 127-1 corresponding to the follower gear 111 is in a loosed state and can roll freely so that the follower gear 111 overruns the main shaft 105. Therefore the follower gear is not working now.

2.3.1.2 Operator rotates the handle 121 counterclockwise to drive the capstan gear 118 rotating counterclockwise. At this moment, the rolling needle 127-2 corresponding to the capstan 118 is in a loosed state, and can roll freely so that the capstan gear 118 overruns the main shaft 105. The idle gears 128 force the follower gear 111 to rotate clockwise, the rolling needles 127-1 corresponding to the follower gear 111 is clamped tightly, to entrain the main shaft to rotate clockwise.

In sum, no matter which direction the handle drives the capstan gear to rotate, it is realized to rotate the main shaft 105 clockwise.

2.3.2 Then, rotate the reversing element 115 relative to the main shaft 105, to re-position the orientation steel ball 124 in the orientation slot 117-2, then the main shaft 105 is set to be able to rotate counterclockwise only, and this embodiment is in the above mentioned second working state. Operator grasps the holding ring 113 with one hand, and rotates the handle 121 clockwise with another hand either clockwise or counterclockwise, the main shaft 105 rotates counterclockwise.

### 3. Further Improvements of the Structure of the Reversing Means 110

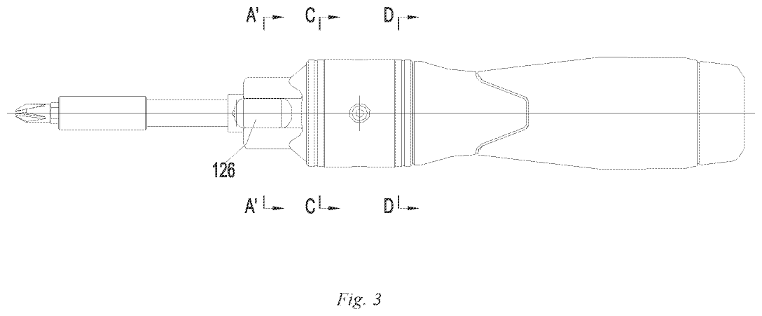

Referring to FIGS. 1, 2 and 3, a slideway parallel to the axis of the main shaft 105 is disposed on head cap 108, and a push button assembly 126 which can slide in the slideway is disposed herein, to control the position of the reversing element 115, so as to set the rotation direction of the main shaft 105. For example, when the push button assembly 126 is toggled to the front side position (i.e., towards the tool bit as shown in FIG. 1), the orientation slot 117-1 of the reversing element 115 is engaged with the orientation steel ball 124, the main shaft 105 is able to rotate clockwise only, and the screwdriver 100 is used to tighten a screw; when the push button assembly 126 is toggled to the rear side position (i.e., leaving from the tool bit as shown in FIG. 3), the orientation slot 117-2 of the reversing element 115 is engaged with the orientation steel ball 124, the main shaft 105 is able to rotate counterclockwise only, and the screwdriver 100 is used to loosen a screw. Of course, the relationship between the push button and the rotation direction of the main shaft can be revered, and this invention does not restrict it.

The control of the reversing element 115 with the push button assembly 126 is realized through a spatial cam mechanism. As shown in FIGS. 7, 8A and 9A, a helical sliding slot 116 is disposed on the external circumference of the reversing element 115. The push button assembly 126 has a portion protruding into the sliding slot 116, such as an arm 126-1 or a steel ball, so as to form the cam mechanism to convert the axial linear movement of the push button assembly 126 to the circular movement of the reversing element 115, i.e., by toggling the push button assembly 126 axially, the arm 126-1 protruding in the sliding slot 116 causes the reversing element 115 to move circularly. Through the cam mechanism, the switching of the push button assembly 126 between the front and rear positions is converted to the switching of the orientation steel ball 124 in the two orientation slots.

If there is no push button assembly 126, operator must grasp the main shaft and the reversing element 115 with two hands respectively (or parts fixed to these two parts and which are easy to be grasped) and rotate them oppositely, to realize the direction-switching. With the push button assembly 126 disposed, operator can push it with only one finger to realize the direction-switching. This improvement eases the implementation of the reversing means 110 greatly.

Furthermore, after using the method of controlling the rotation of the reversing element 115 with the push button assembly 126, the structure of the orientation steel ball 124 and two orientation slot can be cancelled. As long as the reversing element 115 can be pushed with the push button assembly 126, and in turn pushes the rolling needles to the working positions of the one-way clutches, the purpose of the present invention can be realized.

This embodiment further includes structures for containing unnecessary axial movements of each part, such as shoulders, retaining rings or fasteners, etc., and various bearings and oiled bushings, etc., for rotating smoothly, which are not detailed described herein, and this invention does not restrict it.

In normal operation, the holding ring 113 of this embodiment is held stable, i.e., the efficiency is doubled compared to the common screwdrivers without the bidirectional double-speed power transmission. In actual operations, the holding ring 113 can be rotated in opposite direction relative to the handle 121, and then the rotation speed of the main shaft 105 is double of that of the handle 121, i.e., the efficiency is four times of that of the common screwdrivers without the bidirectional double-speed power transmission.

### Embodiment II

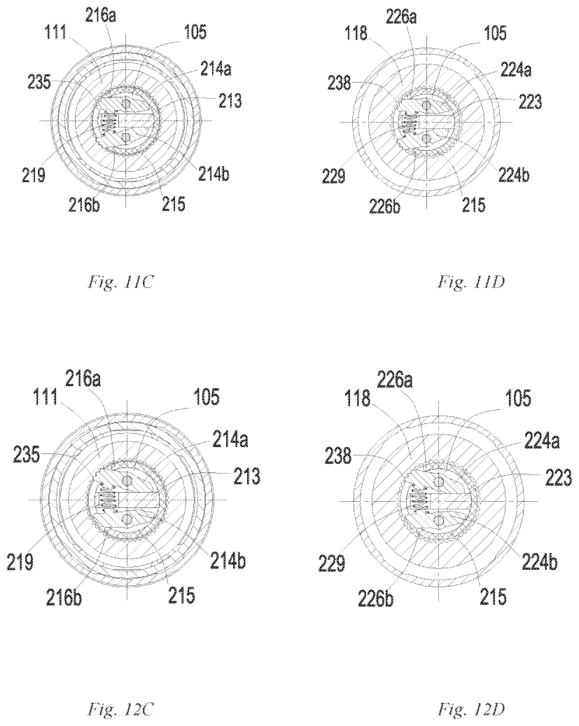

This embodiment is similar to Embodiment I, but replacing the reversing means 110 in Embodiment I to the ratchet-pawl reversing means as shown in FIGS. 11C, 11D, 12C and 12D. Pawl seats are disposed on the main shaft 105, and two opposite swinging pawls are disposed on each of the pawl seat symmetrically, i.e., the pawl seat 223 and pawls 224a and 224b corresponding to the capstan gear 118 in FIGS. 11D and 12D, and the pawl seat 213 and pawls 214a and 214b corresponding to the follower gear 111 in FIGS. 11C and 12C. There are openings on the reversing element 215, two ends of each opening can push the pawls, to change the positioning of the pawls (i.e., to set the rotation direction of the main shaft 105). In FIGS. 11C and 12C, the two ends of the opening of the reversing element 215 are 216a and 216b, and in FIGS. 11D and 12D, the two ends of the opening are 226a and 226b. The inner circumferences of the capstan gear 118 and the follower gear 111 are modified to inner ratchet circumferences 238 and 235, and these two inner ratchet circumferences can be engaged with at least one pawl respectively. Elastic element 219 and 229 are disposed between each pair of the pawls to keep the pawls diverged against the inner ratchet circumference, to assure the reliable engagement between the pawl and the inner ratchet circumference. The working principle of this embodiment is:

FIGS. 11C and 11D correspond to the first working state of this embodiment, while the pawl 224b is engaged with the inner ratchet circumference 238, and the pawl 214b is engaged with the inner ratchet circumference 235. At this moment, the opening's end 216a of the reversing element 215 pushes the pawl 214a, and the opening's end 226a of the reversing element 215 pushes the pawl 224a, to disengage with their respective inner ratchet circumference 235 and 238, so that these pawls are inactive.

If rotate the handle 121 clockwise now, to drive the capstan gear 118 to rotate clockwise, the pawl 224b will slide over the inner ratchet circumference 238, and won't delivery torque to the main shaft 105. And the follower gear 111 will be rotating counterclockwise driven by the idle gears 128, the inner ratchet circumference 235 will deliver torque to the main shaft 105 through the pawl 214b engaged therewith, and cause the main shaft 105 to rotate counterclockwise.

If rotate the handle 121 counterclockwise, to drive the capstan gear 118 to rotate counterclockwise, the inner ratchet circumference 238 will deliver torque to the main shaft 105 through the pawl 224b engaged therewith, and cause the main shaft 105 to rotate counterclockwise. And the follower gear 111 will be rotating clockwise, the pawl 214b will slide over the inner ratchet circumference 235, i.e., the follower gear 111 will overrun the main shaft 105.

Thus it can be seen, no matter the handle drives the capstan gear to rotate clockwise or counterclockwise, the main shaft 105 rotates counterclockwise in the first working state.

FIGS. 12C and 12D correspond to the second working state of this embodiment, while the reversing element 215 rotated for an angle clockwise, to have the pawl 224a engaged with the inner ratchet circumference 238, and the pawl 214a engaged with the inner ratchet circumference 235. At this moment, the opening's end 216b of the reversing element 215 pushes the pawl 214b, and the opening's end 226b of the reversing element 215 pushes the pawl 224b, to disengage with their respective inner ratchet circumference 235 and 238, so that these pawls are inactive. Based on the same principle, no matter the handle drives the capstan gear to rotate clockwise or counterclockwise, the main shaft 105 rotates clockwise in the second working state.

Therefore, by toggling the reversing element 215 relative to the main shaft 105, to have the right pawls to engage with the inner ratchet circumferences with the ends of the openings, it can be realized to switch between the above mentioned first working state and the second working state.

### Embodiment III

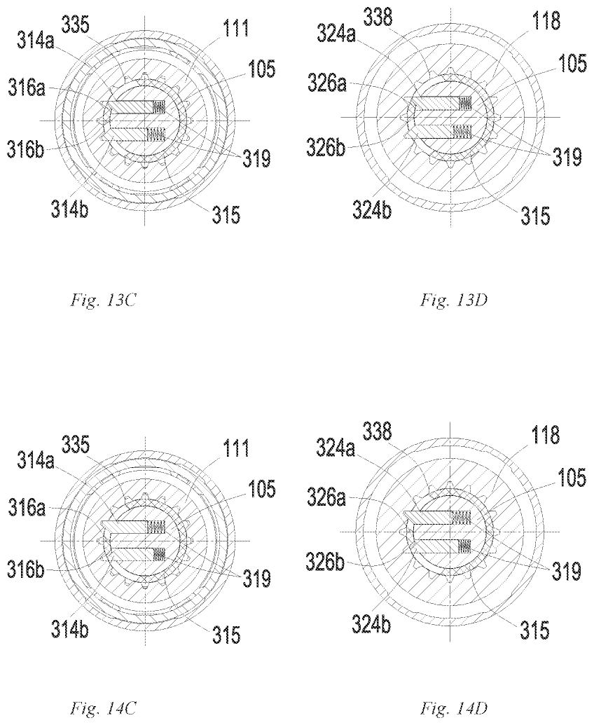

This embodiment is similar to Embodiment I, but replacing the reversing means 110 in Embodiment I to the reversing means with detents as shown in FIGS. 13C, 13D, 14A and 14D. Two grooves are disposed on the main shaft 105 bilaterally parallel to the axis thereof, and two detents are disposed in the grooves respectively, i.e., the detents 324a and 324b corresponding to the capstan gear 118 as shown in FIGS. 13D and 14D, and the detents 314a and 314b corresponding to the follower gear 111 as shown in FIGS. 13C and 14C. The outer ends of the detents 314a and 314b are inclined surfaces, and these two inclined surfaces face each other as a “V” shape. There are openings on the reversing element 315, ends of the openings can be used to push the outer ends of the detents, to depress the detents into the grooves, so as to change the working positions of the detents (i.e., to set the rotation direction of the main shaft). In FIGS. 13C and 14C, the acting ends of openings of the reversing element 315 are 316a and 316b, and in FIGS. 13D and 14D, the acting ends of openings of the reversing element 315 are 326a and 326b. The acting ends of openings are located between the two inclined surfaces facing each other as a “V” shape. The inner circumferences of the capstan gear 118 and the follower gear 111 are modified to toothed inner circumferences 338 and 335 formed with multiple teeth, for engaging with at least one detent respectively. Each detent is urged by a spring 19 disposed within the groove for the detent on the main shaft 105, which assures a reliable engagement between the detent and the toothed inner circumference. The working principle of this embodiment is:

FIGS. 13C and 13D correspond to the first working state of this embodiment, while the detent 324a is depressed into the groove through the pushing by the opening's acting end 326a of the reversing element 315, and the detent 324b is engaged with the toothed inner circumference 338; the detent 314a is depressed into the groove through the pushing by the opening's acting end 316a of the reversing element 315, and the detent 314b is engaged with the toothed inner circumference 335.

If rotate the handle 121 clockwise now, to drive the capstan gear 118 to rotate clockwise, the toothed inner circumference 338 will deliver torque to the main shaft 105 through the detent 324b engaged therewith, and cause the main shaft 105 to rotate clockwise. And the follower gear 111 will be rotating counterclockwise driven by the idle gears 128, the detent 314b will slide over the toothed inner circumference 335, and won't delivery torque to the main shaft 105, i.e., the follower gear 111 will overrun the main shaft 105.

If rotate the handle 121 counterclockwise, to drive the capstan gear 118 to rotate counterclockwise, the detent 324b will slide over the toothed inner circumference 338, and won't delivery torque to the main shaft 105. And the follower gear 111 will be rotating clockwise driven by the idle gears 128, the toothed inner circumference 335 will deliver torque to the main shaft 105 through the detent 314b engaged therewith, and cause the main shaft 105 to rotate clockwise.

Thus it can be seen, no matter the handle drives the capstan gear to rotate clockwise or counterclockwise, the main shaft 105 rotates clockwise in the first working state.

FIGS. 14C and 14D correspond to the second working state of this embodiment, while the detent 324b is depressed into the groove through the pushing by the opening's acting end 326b of the reversing element 315, and the detent 324a is engaged with the toothed inner circumference 338; the detent 314b is depressed into the groove through the pushing by the opening's acting end 316b of the reversing element 315, and the detent 314a is engaged with the toothed inner circumference 335. Based on the same principle, no matter the handle drives the capstan gear to rotate clockwise or counterclockwise, the main shaft 105 rotates counterclockwise in the second working state.

Therefore, by toggling the reversing element 315 relative to the main shaft 105, to have the right detents to engage with the toothed inner circumferences with the acting ends of the openings, it can be realized to switch between the above mentioned first working state and the second working state.

### Embodiment IV

This embodiment is a transformation of Embodiment III on the detents, i.e., modifying the outer ends of the detents to flat surfaces. Take the components corresponding to the capstan gear 118 as shown in FIG. 15 as an example, the outer ends of the detents 424a and 424b are flat, and the opening's acting ends 426a and 426b of the reversing element 415 are located between the two detents, for pushing the outer ends of the detents and depressing the detents into the grooves, so as to change the working positions of the detents (i.e., to set the rotation direction of the main shaft). The toothed inner circumference 438 of the capstan gear 118 can be engaged with at least one detent. It is appreciated that the working principle of this embodiment is similar to the Embodiment III, and the purpose of the present invention can be realized as well.

### Embodiment V

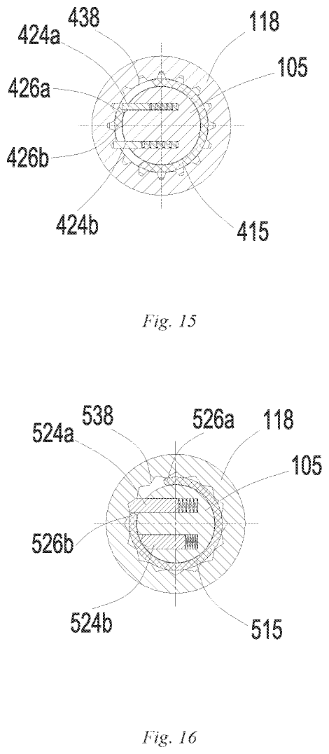

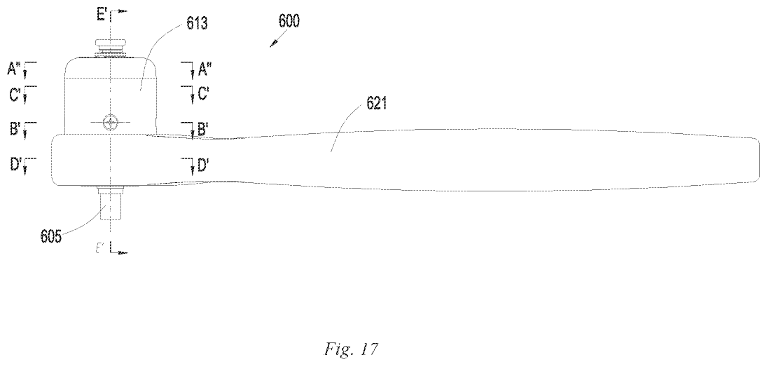

This embodiment is another transformation of Embodiment III on the detents and the reversing element. Take the components corresponding to the capstan gear 118 as shown in FIG. 16 as an example, the outer ends of the detents 524a and 524b are toothed shaped matching with the toothed inner circumference 538 of the capstan gear 118, and the opening's acting ends 526a and 526b of the reversing element 415 are located at outer flank of the detents, for pushing the outer ends of the detents and depressing the detents into the grooves, so as to change the working positions of the detents (i.e., to set the rotation direction of the main shaft). The toothed inner circumference 538 of the capstan gear 118 can be engaged with at least one detent. It is appreciated that the working principle of this embodiment is similar to the Embodiment III, and the purpose of the present invention can be realized as well.

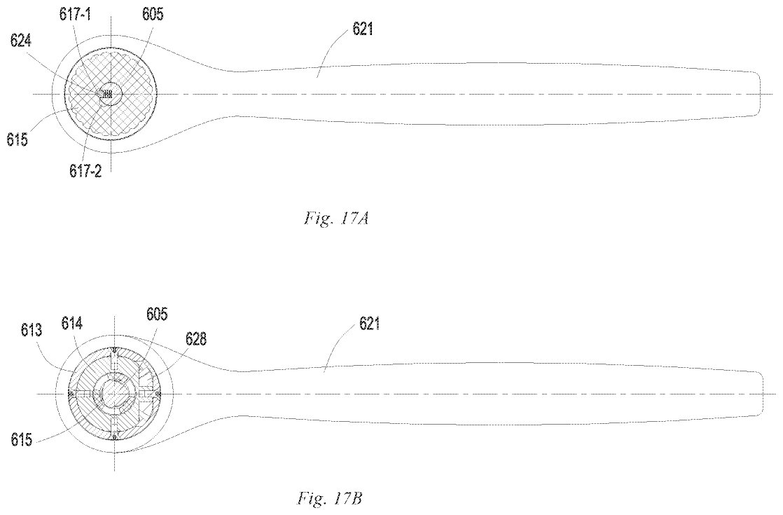

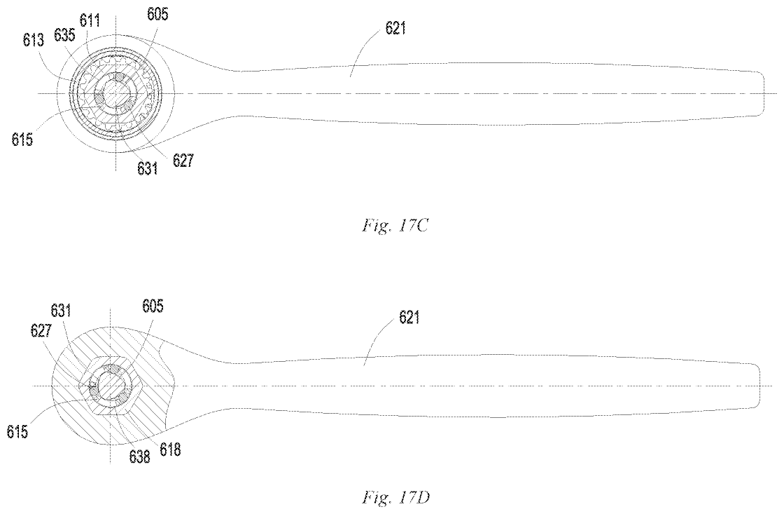

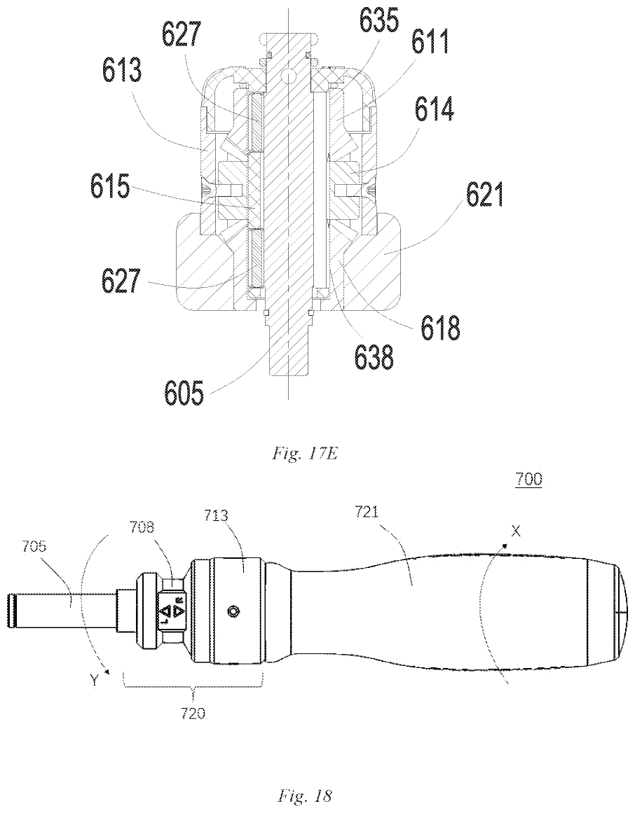

Embodiment VI This embodiment is a torque wrench 600 utilizing the dual-way mechanical rectifier of the present invention, which achieves bidirectional double-speed power transmission through a driving mechanism similar to the Embodiment I. The driving mechanism also includes a driving means and a reversing means, for realizing the rotation direction switching of the main shaft, as shown in the structure of FIGS. 17, and 17A to 17E.

The torque wrench 600 comprises a main shaft 605, a driving mechanism and a rotation means. In this embodiment, the rotation means is a handle 621, on which the torque input at either direction (either clockwise or counterclockwise) is delivered to the main shaft 605 through the driving mechanism, so that the main shaft 605 outputs torque at a predetermined direction (clockwise or counterclockwise). The driving means of this embodiment includes a capstan gear 618, a follower gear 611, an idle gear 628 which engages with the capstan gear and the follower gear together, and a transmission seat 614. The capstan gear 618, the follower gear 611 and the transmission seat 614 are sleeved on the outside of the reversing means. The capstan gear 618 is fixed coupling with the handle 621. The transmission seat 614 is used to mount the idle gear 628, and to fix the holding ring 613.

Profiled surfaces 631 are disposed on the main shaft 605. The reversing means includes a reversing element 615 with two sets of slots and rolling needles 627 disposed within the slots, which are corresponding to the capstan gear 618 and the follower gear 611 to realize the function of one-way clutches. Particularly, around the capstan gear 618, the rolling needles 627 pushed by the reversing element 615 are engaged with the profiled surfaces 631 of the main shaft and the inner circumference 638; around the follower gear 611, the rolling needles 627 pushed by the reversing element 615 are engaged with the profiled surfaces 631 of the main shaft and the inner circumference 635. Two orientation slots 617-1 and 617-2 are provided at one end of the reversing element 615, to engage with an orientation steel ball 624 on the main shaft 605, to realize the function of a reverser. The working principle of this embodiment is similar to that of the Embodiment I: operator grasps the handle 621 and the holding ring 613 with two hands respectively, wherein the holding ring 613 keeps stable. No matter the handle 621 rotates clockwise or counterclockwise, the main shaft 605 will rotate in a direction set according to the orientation slot of the reversing element 615.

In other embodiments, the reversing means in the torque wrench 600 may be replaced with the ratchet-pawl reversing means or the reversing means with detents in the Embodiments II to V, and the purpose of the present invention can be realized as well.

The abovementioned manual tool could be a manual drill or other similar tool, in additional to the screwdriver and torque wrench, as long as the rotation means (a handle) is coaxial with the main shaft, it can utilize the dual-way mechanical rectifier of the present invention to realize that the main shaft will output torque in a predetermined direction, no matter how the rotation means rotates, and the predetermined direction of the main shaft can be switched.

The dual-way mechanical rectifier of the present invention can be implemented in other systems or apparatus. In other embodiments which also include a main shaft, a driving mechanism and a rotation means, the bevel gear drive are replaced with other transmission solution such as spur gear drive, spur gear plus shaft drive, pulley drive plus shaft drive or 3D pulley drive, etc., to force the capstan gear and the follower gear to always rotate in opposite directions. As long as the reversing means with the functions of one-way clutches and a reverser together of the present invention in the driving mechanism, the other embodiments can also realize the purpose of the present invention, i.e., the input force of the rotation means can be either clockwise or counterclockwise, the input force in either direction can be effectively utilized to deliver to the main shaft and be output in a predetermined direction, and the rotation direction of the main shaft can be switched conveniently. In the embodiments of the other systems or apparatus, the holding ring of the reversing means of the driving mechanism also can be replaced to a mounting means, such as a supporting frame, acting as the mounting base of the whole system or apparatus.

### Embodiment VII

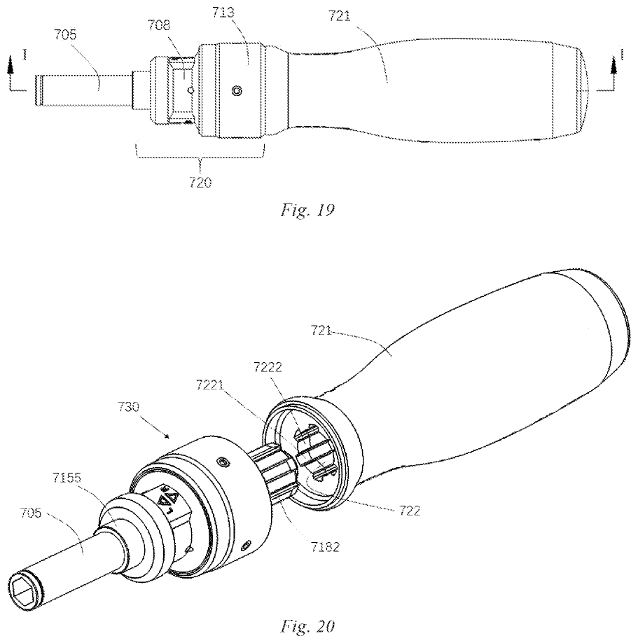

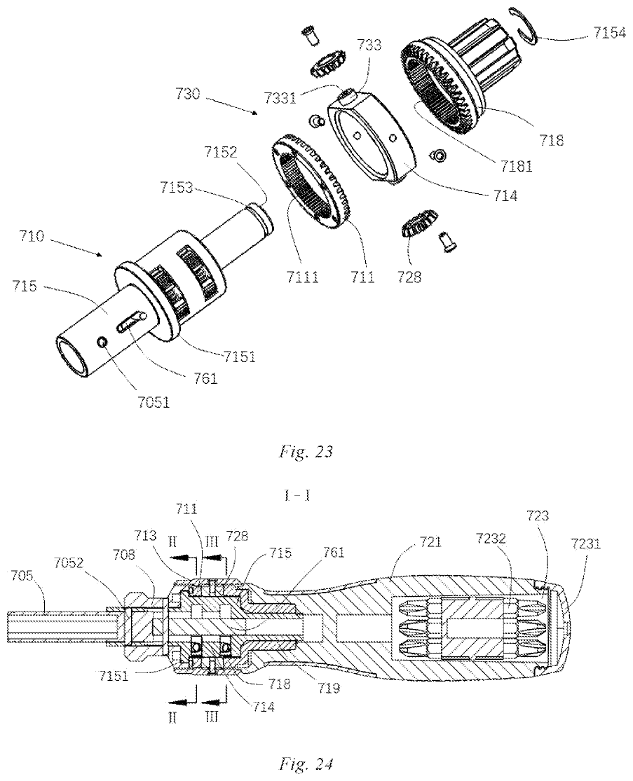

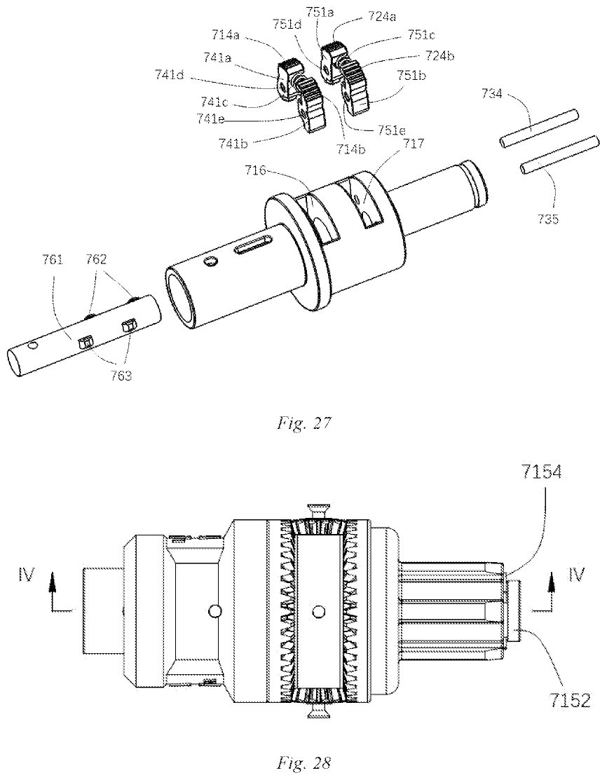

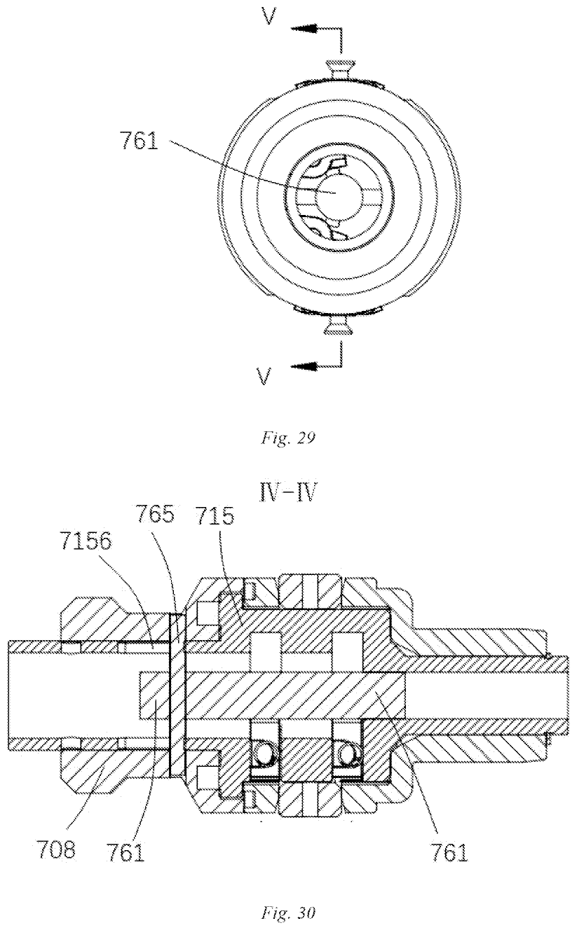

FIGS. 18 to 31 show Embodiment VII. In this embodiment, there is disclosed a manual screwdriver 700 incorporating a dual-way mechanical rectifier according to the present invention. The screwdriver 700 can achieve bidirectional double-speed power transmission by means of the driving mechanism 720 shown in FIGS. 18 and 22. The driving mechanism 700 includes a driving means 730 and a reversing means 710 shown in FIGS. 23, 26 and 27, which can reverse rotation direction of a main shaft.

FIGS. 23 and 24 show the structures and assembly of the driving means 730 and the reversing means 710. As used in this embodiment, the term “bidirectional double-speed power transmission” or “dual-way transmission” has the same definition as in Embodiment I. That is, for a handle 721 serving as the rotation means, an input torque may be in either of a clockwise direction and a counterclockwise direction.

Regardless of which direction the input torque is in, it can be utilized efficiently. As used herein, the term “reversible” means that an output torque of the main shaft 705 may be either in the clockwise direction or in the counterclockwise direction, as needed. As used in the specification, the clockwise or counterclockwise direction is defined as a rotation direction viewed axially from the main shaft 705 toward the handle 721.

The structure, operation and mechanism of the manual screwdriver in this embodiment are detailed below.

### 1. Overall Structure of Screwdriver

Referring to FIGS. 18, 19 and 20, the screwdriver 700 includes the main shaft 705, the driving mechanism 720 and the rotation means. In this embodiment, the rotation means is said handle 721, and a torque input to the handle 721 in either direction (clockwise or counterclockwise) will be transmitted by the driving mechanism 720 to the main shaft, resulting in an output torque of the main shaft 705 in a predetermined direction (clockwise or counterclockwise). One end of the driving mechanism 720 is coupled to the main shaft 705, and the other end is coupled to the handle 721. The driving mechanism 720 can transmit a driving torque from the handle 721 to the main shaft 705, which may be then output through any of a variety of tool bits mounted in a bit holder (see FIG. 1 and Embodiment I) mounted on the main shaft 705.

Referring to FIG. 18, the screwdriver 700 further includes a chuck 708 and a holding ring 713, which are visible from the outside.

The holding ring 713 and the handle 721 can be respectively held by an operator's hands. Specifically, the holding ring 713 may be held stationary, while the handle 721 may be rotated in any direction (clockwise or counterclockwise) relative to the holding ring 713. The stationary holding ring 713 may serve as a reference for rotation of the various components in the screwdriver 700.

### 2. Driving Mechanism

As shown in FIGS. 21, 22, 23 and 24, the driving mechanism 720 includes the driving means 730 and the reversing means 710, which enable reversible, bidirectional double-speed power transmission of the main shaft 705. The driving means 730 is sleeved on the reversing means 710, which is in turn sleeved on the main shaft 705 so as to cover part of the main shaft 705. The reversing means 710 has two functions: i) cooperating with the driving means 730 to converting inputs in both directions into outputs in one direction (i.e., functioning as a one-way clutch); and ii) switching an output between different directions (i.e., functioning as a reverser).

### 2.1. Structure of Driving Means

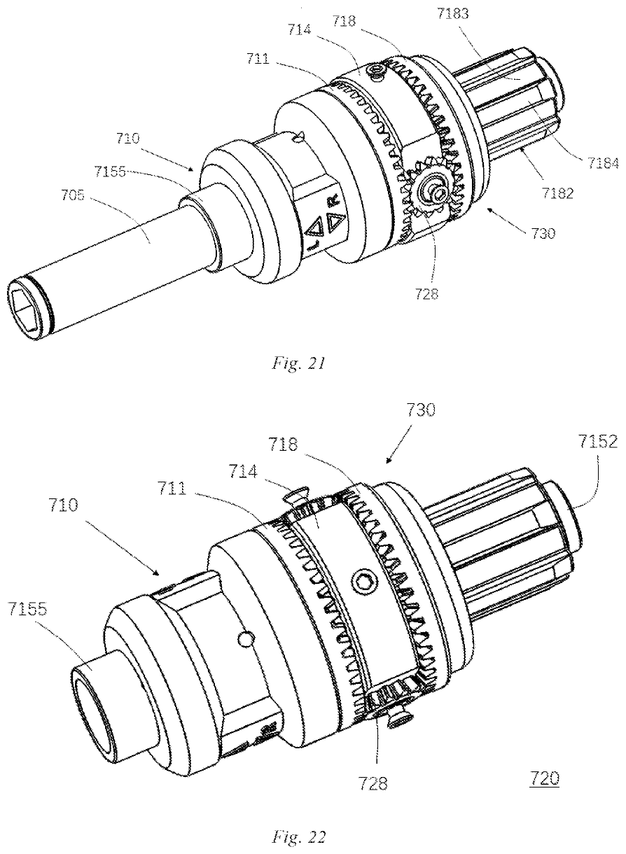

As shown in FIG. 23, the driving means 730 includes four bevel gears and a transmission seat 714. The four bevel gears include a capstan gear 718, a follower gear 711 and two idle gears 728 engage the follower gear 711 with the capstan gear 718. Although the use of the two idle gears 728 enables balanced power transmission, it is also possible to use only one idle gear 728 without affecting the functions of present invention or limiting the invention in any sense. Referring to FIGS. 20 and 24, the capstan gear 718 and the handle 721 are securely engaged together to transmit a torque from the handle 721. Preferably, the handle 721 defines a first bore 722 on its side proximate the driving mechanism 720, as well as a plurality of first grooves 7221 and a plurality of first ribs 7222 on an interior side wall of the first bore 722, which extend in a lengthwise direction of the handle 721. The first grooves 7221 and the first ribs 7222 are equidistantly spaced circumferentially on the interior side wall of the first bore 722. Referring to FIGS. 20 and 21, the capstan gear 718 is provided, on its side facing the handle 721, with a cylindrical member 7182 which defines, on a circumference of its exterior side wall, a plurality of second grooves 7183 and a plurality of second ribs 7184 extending in a lengthwise direction thereof. The second grooves 7183 and the second ribs 7184 are equidistantly spaced circumferentially around the cylindrical member 7182. The cylindrical member 7182 can be inserted into the first bore 722 so that the first ribs 7222 are received in the second grooves 7183 and the second ribs 7184 are received in the first grooves 7221, thereby securing engaging the capstan gear 718 with the handle 721. It would be understood that the secure engagement of the capstan gear with the handle is not limited to being achieved in the illustrated manner, and any other method capable of securely engaging the capstan gear with the handle can also be suitably used in this embodiment.

Referring to FIGS. 21, 22, 23 and 24, the capstan gear 718, the transmission seat 714 and the follower gear 711 are coaxially sleeved on a reversing element 715 of the reversing means 710 in sequence by clearance fits. The reversing means 710 creates a one-way clutch between the capstan gear 718 and the reversing element 715 and another one-way clutch between the follower gear 711 and the reversing element 715. Thus, in one direction, the capstan gear 718 drives the reversing element 715 to rotate, while the follower gear 711 overruns the reversing element 715. In the other direction, the capstan gear 718 and the follower gear 711 are functionally interchanged—the follower gear 711 drives the reversing element 715 to rotate, while the capstan gear 718 overruns the reversing element 715. Specific implementations of the one-way clutches will be described in detail below.

FIGS. 20, 23 and 24 shows how the transmission seat 714, the reversing element 715 and the holding ring 713 are coupled together. The transmission seat 714 can rotate relative to the reversing element 715. The transmission seat 714 has two radial idle gears axles 733, on which the idle gears 728 are mounted. The idle gears 728 allow the capstan gear 718 and the follower gear 711 to rotate always in opposite directions. That is, when the capstan gear 718 is rotating clockwise, the follower gear 711 is rotating counterclockwise. On the contrary, when the capstan gear 718 is rotating counterclockwise, the follower gear 711 is rotating clockwise.

The transmission seat 714 further includes radial threaded holes for securing the holding ring 713. The holding ring 713 is secured to the transmission seat 714 with screws. In this embodiment, the idle gear axles 733 are provided with threaded holes 7331 extending along their respective axes. For the sake of structural compactness, the threaded holes 7331 may also be used to secure the holding ring 713. In this case, the holding ring 113 may further function to restrict axial displacement of the idle gears 728. Of course, according to the present invention, it is also possible to secure the holding ring 713 to the transmission seat 714 simply by the threaded holes, with axial displacement of the idle gears being restricted by axial stoppers provided with the aid of the threaded holes or by retainer rings or other retaining elements provided on the idle gear axles.

### 2.2. Structure and Mechanism of Reversing Means

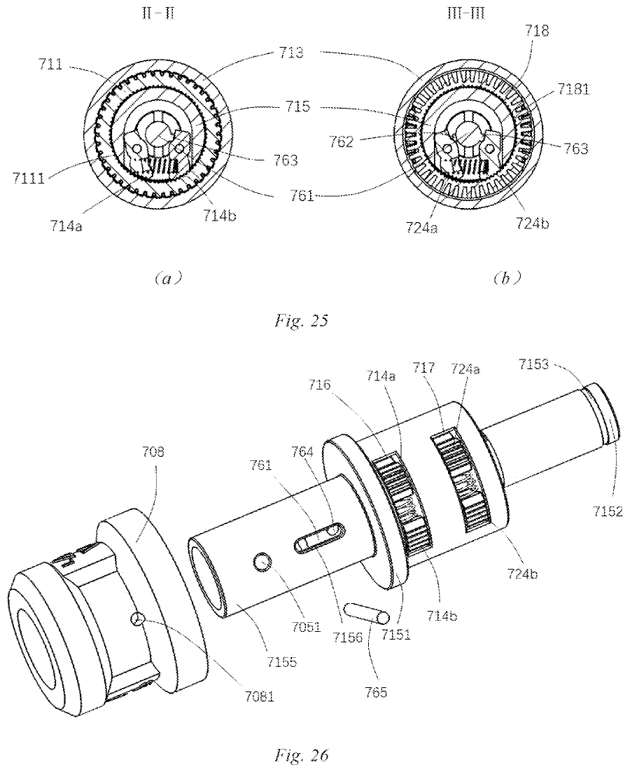

As shown in FIGS. 25, 26 and 27, the driving means 730 is sleeved on the reversing means 710. The reversing means 710 includes the reversing element 715 and two sets of pawls 714a and 714b, 724a and 724b.

An end portion 7155 of the reversing element 715 is sleeved on part of an external surface of the main shaft 705 and securely attached to the main shaft 705 so as to be coaxial with the main shaft. The reversing element 715 can be driven by the driving means 730 to rotate to cause the main shaft 705 to rotate therewith. The reversing element 715 has a hollow interior and can receive the main shaft 705 therein at its one end. In some embodiments, an inner wall of the reversing element 715 on its side proximate the main shaft 705 defines a polygonal (e.g., hexagonal) bore, and a portion of the main shaft 705 to be coupled to the reversing element 715 has an external shape matching the shape of the inner wall of the reversing element 715. As such, once the main shaft 705 is inserted into the reversing element 715, it can rotate together with the reversing element 715. In some embodiments, as shown in FIGS. 24 and 26, the reversing element 715 is provided with a through hole 7051 radially extending through its wall, and the main shaft 705 is provided with another through hole radially extending therethrough. After the main shaft 705 is inserted into the reversing element 715, the through hole in the main shaft 705 may be aligned with the through hole 7051 in the reversing element 715, and a pin 7052 (see FIG. 24) may be successively inserted in those through holes, thus securely coupling the main shaft 705 to the reversing element 715 and enabling the main shaft 705 to rotate together with the reversing element 715. In some embodiments, the portion of the main shaft 705 to be coupled to the reversing element 715 is polygonal and matches the inner wall of the reversing element 715 in shape. Moreover, a through hole 7051 is provided in the wall of the reversing element 715, and a through hole corresponding to the through hole 7051 is provided in the main shaft 715. Further, a pin 7052 can be successively inserted into those through holes. It would be understood that the secure coupling of the main shaft 705 to the reversing element 715 is not limited to being achieved in the illustrated manner, and any other method capable of securely coupling the main shaft to the reversing element and thereby enabling them to rotate together can also be suitably used in this embodiment.

Referring to FIGS. 23 and 26, a collar 7151 is provided circumferentially around the reversing element 715, and the follower gear 711, the transmission seat 714 and the capstan gear 718 are sequentially disposed in the direction from the collar 7151 toward the handle 721. Another end portion 7152 of the reversing element 715 protrudes out of the capstan gear 718 on its side proximate the handle 721, and a circumferentially-extending third groove 7153 is provided in the end portion 7152. A ring-shaped elastic element 7154 defining an opening is provided in the third groove 7153 to restrain the follower gear 711, transmission seat 714 and the capstan gear 718 along an axis of the reversing element 715. It would be understood that the reversing element 715 is not limited to being assembled with the follower gear 711, the transmission seat 714 and the capstan gear 718 in the illustrated manner, and any other assembly method capable of restraining the follower gear, the transmission seat and the capstan gear along the axis of the reversing element can also be suitably used in this embodiment.

Referring to FIG. 26, the reversing element 715 defines a first pawl compartment 716 and a second pawl compartment 717. Two swinging pawls 714a and 714b are accommodated in the first pawl compartment 716, and two swinging pawls 724a and 724b are accommodated in the second pawl compartment 717. Preferably, the pawls 714a and 714b are oppositely oriented, and the pawls 724a and 724b are oppositely oriented. Here, by “oppositely”, it is intended to mean that in each of the pawl compartments, ratchet teeth on the two pawls are oriented in different directions. Referring to FIGS. 23 and 25, the follower gear 711 is provided with an annular inner ratchet circumference 7111 on its inner surface, which can intermesh with at least one of the pawls 714a or 714b in the first pawl compartment 716. The capstan gear 718 is provided with an annular inner ratchet circumference 7181 on its inner surface, which can intermesh with at least one of the pawls 724a or 724b in the second pawl compartment 717. Operation of this embodiment is explained below.

In a first working state, the pawl 714b protrudes out of the first pawl compartment 716 from an opening thereof, and the pawl 724b protrudes out of the second pawl compartment 717 from its opening. As the pawls 714a and 724a are separate from the respective inner ratchet circumferences, they are not active.

In this state, when the handle 721 is rotated clockwise, the capstan gear 718 is driven to rotate clockwise, and the pawl 724b moves over the inner ratchet circumference 7181 without transmitting a torque to the reversing element 715. At the same time, driven by the idle gears 728, the follower gear 711 rotates counterclockwise, and the inner ratchet circumference 7111 transmits, via the pawl 714b that intermeshes with it, a torque to the reversing element 715, which causes the reversing element 715 and hence the main shaft 705 to rotate counterclockwise. Here, the clockwise direction is defined as the X direction shown in FIG. 21, and the counterclockwise direction is defined as the Y direction shown in FIG. 21.

When the handle 721 is rotated counterclockwise, the capstan gear 718 is driven to rotate counterclockwise, and the inner ratchet circumference 7181 transmits, via the pawl 724b that intermeshes with it, a torque to the reversing element 715, which causes the reversing element 715 and hence the main shaft 705 to rotate counterclockwise. At the same time, the follower gear 711 rotates clockwise, and the pawl 714b moves over the inner ratchet circumference 7111. That is, the follower gear 711 overruns the reversing element 715.

In this way, in the first working state, irrespective of the handle 721 driving the capstan gear 718 to rotate clockwise or counterclockwise, the main shaft 705 will always rotate counterclockwise in this embodiment.

In a second working state, the pawl 714a protrudes out of the first pawl compartment 716 from its opening, and the pawl 724a protrudes out of the second pawl compartment 717 from its opening. As the pawls 714b and 724b are separate from the respective inner ratchet circumferences, they are not active.

In this state, when the handle 721 is rotated clockwise, the capstan gear 718 is driven to rotate clockwise, and the follower gear 711 is driven by the idle gears 728 to rotate counterclockwise. Moreover, the inner ratchet circumference 7111 moves over the pawl 714a without transmitting a torque to the reversing element 715, while the pawl 724a intermeshing the inner ratchet circumference 7181 of the capstan gear 718 transmits a torque to the reversing element 715, which causes the reversing element 715 and hence the main shaft 705 to rotate clockwise.

When the handle 721 is rotated counterclockwise, the capstan gear 718 is driven to rotate counterclockwise, and pawl 724a moves over the inner ratchet circumference 7181 transmitting a torque to the reversing element 715. At the same time, driven by the idle gears 728, the follower gear 711 rotates clockwise, and the inner ratchet circumference 7111 intermeshing with the pawl 714a transmits a torque to the reversing element 715, which causes the reversing element 715 and hence the main shaft 705 to rotate clockwise.

and the inner ratchet circumference 7181 transmits, via the pawl 724b that intermeshes with it, a torque to the reversing element 715, which causes the reversing element 715 and hence the main shaft 705 to rotate counterclockwise. At the same time, the follower gear 711 rotates clockwise, and the pawl 714b moves over the inner ratchet circumference 7111. That is, the follower gear 711 overruns the reversing element 715.

In this way, in the second working state, irrespective of the handle 721 driving the capstan gear 718 to rotate clockwise or counterclockwise, the main shaft 705 will always rotate clockwise in this embodiment.

Thus, a switching between the above-discussed first and second working states can be achieved by swinging the pawls 714a, 714b and pawls 724a, 724b to proper positions so that one of the pawls 714a and 714b protrudes out of the first pawl compartment 716 from its opening and a corresponding one of the pawls 724a and 724b protrudes out of the second pawl compartment 717 from its opening.

Referring to FIG. 27, the pawls 714a and 714b are provided on two respective pawl members. That is, the pawl 714a is provided on a pawl member 741a, and the pawl 714b is provided on a pawl member 741b. The pawl members 741a and 741b are disposed in the first pawl compartment 714 in opposition to each other, and a first elastic element 741c is provided between the two. The first elastic element 741c can elastically urge the pawl members 741a and 741b to bring them into an opened configuration. Likewise, the pawls 724a and 724b are provided on two respective pawl members. That is, the pawl 724a is provided on a pawl member 751a, and the pawl 724b is provided on a pawl member 751b. The pawl members 751a and 751b are disposed in the second pawl compartment 717 in opposition to each other, and a second elastic element 751c is provided between the two. The second elastic element 751c can elastically urge the pawl members 751a and 751b to bring them into an opened configuration. The pawl member 741a defines a through hole 741d therein, and the pawl member 751a defines a through hole 751d therein. A first auxiliary shaft 734 is sequentially inserted into the through holes 741d and 751d in the pawl members 741a and 751a, coupling the pawl members 741a and 751a to the reversing element 715 while allowing them to pivot about the first auxiliary shaft 734. Similarly, the pawl member 741b defines a through hole 741e therein, and the pawl member 751b defines a through hole 751e therein. A second auxiliary shaft 735 is sequentially inserted into the through holes 741e and 751e in the pawl members 741b and 751b, coupling the pawl members 741b and 751b to the reversing element 715 while allowing them to pivot about the second auxiliary shaft 735. The first auxiliary shaft 734 and the second auxiliary shaft 735 are parallel to the reversing element 715, but their center axes do not coincide with a center axis of the reversing element 715.

Referring to FIGS. 27, 29 and 31, in order to facilitate control of swinging of the pawl members 741a and 741b, 751a and 751b, a reversing pin 761 is provided in the reversing element 715. The reversing pin 761 is inserted into the reversing element 715 through an opening of the end portion 7155 of the reversing element 715. As a result of the reversing pin 761 being inserted into the reversing element 715, it is located between the pawl members 741a and 741b and between the pawl members 751a and 751b. The reversing pin 761 is provided thereon with driving members capable of driving the pawl members to swing. As a result of the reversing pin 761 being switched between positions, the driving members can drive the respective pawl members to swing. Consequently, the different pawls can intermesh with the capstan gear or the follower gear, altering a predetermined direction of the main shaft 705.

In some embodiments, the driving member includes studs provided on the reversing pin 761. Specifically, the reversing pin 761 is provided on its side facing the pawl members 741a, 751a with first studs 762 corresponding to these two pawl members 741a, 751a. Moreover, it is also provided on its side facing the pawl members 741b, 751b with second studs 763 corresponding to these two pawl members 741b, 751b. The reversing pin 761 can move along the axis of the reversing element 715. When it reaches a first position, the second studs 763 come in contact with the pawl members 741b, 751b on the same side, while the first studs 762 are separate from the pawl members 741a, 751a on the same side. When the reversing pin 761 reaches a second position, the second studs 763 are separate from the pawl members 741b, 751b on the same side, while the first studs 762 come in contact with the pawl members 741a, 751a on the same side.

Referring to FIGS. 25 and 31, when the second studs 763 come in contact with the respective pawl members 741b, 751b, the first studs 762 are separate from the pawl members 741a, 751a. At this time, when the second studs 763 contacting the pawl members 741b, 751b urge these two pawl members 741b, 751b to swing about the second auxiliary shaft 735 inwardly (i.e., away from ends of the pawl compartment in its lengthwise direction), the pawl 714b will be brought away from the inner ratchet circumference 7111 and the pawl 724b will be brought away from the inner ratchet circumference 7181. Meanwhile, the pawl member 741a is urged by the first elastic element 741c to swing outwardly, causing the pawl 714a to protrude out of the first pawl compartment 716 from its opening and intermesh with the inner ratchet circumference 7111. Moreover, the pawl member 751a is urged by the second elastic element 751c to swing outwardly, causing the pawl 724a to protrude out of the second pawl compartment 717 from its opening and intermesh with the inner ratchet circumference 7181. As a result, the screwdriver 700 is brought into the second working state.

When the first studs 762 come in contact with the respective pawl members 741a, 751a, the second studs 763 are separate from the pawl members 741b, 751b. At this time, when the first studs 762 contacting the pawl members 741a, 751a urge these two pawl members 741a, 751a to swing about the first auxiliary shaft 734 inwardly (i.e., away from ends of the pawl compartment in its lengthwise direction), the pawl 714a will be brought away from the inner ratchet circumference 7111 and the pawl 724a will be brought away from the inner ratchet circumference 7181. Meanwhile, the pawl member 741b is urged by the first elastic element 741c to swing outwardly, causing the pawl 714b to protrude out of the first pawl compartment 716 from its opening and intermesh with the inner ratchet circumference 7111. Moreover, the pawl member 751b is urged by the second elastic element 751c to swing outwardly, causing the pawl 724b to protrude out of the second pawl compartment 717 from its opening. As a result, the screwdriver is brought into the first working state.

Referring to FIGS. 26 and 30, the chuck 708 is sleeved on the reversing element 715 to control movement of the reversing pin 761 along the axis of the reversing element 715. The reversing element 715 is provided in its wall with a transverse slot 7156 extending along its axis, and a through hole 7081 is provided in the chuck 708 at a location corresponding to the transverse slot 7156. A through hole 764 is provided in the reversing pin 761 at a location corresponding to the transverse slot 7156, and a third pin 765 is sequentially inserted through the through hole 7081 in the chuck 708, the transverse slot 7156 and the through hole 764 in the reversing pin 761. When the chuck 708 is moved along the axis of the reversing element 715, the reversing pin 761 is driven to move therewith. The transverse slot 7156 has two ends. When the third pin 765 comes in contact with the end of the transverse slot 7156 farther away from the pawls as a result of the reversing pin 761 being driven by the chuck 708 to move away from the pawls, the reversing pin 761 reaches said second position, and the first studs 762 come in contact with the pawl members 741a, 751a on the same side. When the third pin 765 comes in contact with the end of the transverse slot 7156 closer to the pawls as a result of the reversing pin 761 being driven by the chuck 708 to move toward the pawls, the reversing pin 761 reaches said first position, and the second studs 763 come in contact with the pawl members 741b, 751b on the same side.

In some embodiments, the reversing pin 761 may be brought in contact with the pawl members 741, 751 on one side and separated from the pawl members 741, 751 on the other side by being rotated circumferentially with respect to the reversing element 715. For example, when the reversing pin 761 is clockwise rotated to a first position, those of the studs on the same side of the reversing pin 761 as the pawl members 741b, 751b come in contact with these pawl members 741b, 751b, enabling the pawl members 741a, 751a to protrude out of the respective pawl compartments from their openings. When the reversing pin 761 is counterclockwise rotated to a second position, those of the studs on the same side of the reversing pin 761 as the pawl members 741a, 751a come in contact with these pawl members 741a, 751a, enabling the pawl members 741b, 751b to protrude out of the respective pawl compartments from their openings. A spatial cam mechanism similar to that shown in FIG. 7 may be used to enable rotation of the reversing pin 761, except that, in contrast to the spatial cam mechanism of FIG. 7 that is provided on the main shaft, the spatial cam mechanism of this embodiment is disposed on the reversing pin 761. Particular reference can be made to FIG. 35 of Embodiment VIII. A helical sliding slot 845 may be provided in an end portion of the reversing pin 761 away from the pawls, and a transverse slot 7156 may be provided in the reversing element 715. The chuck 708 may have a portion passing through the transverse slot 7156 into the sliding slot 845, such as an arm 846 or a steel ball. This arrangement allows axial linear movement of the chuck 708 to be converted into circular movement of the reversing pin 761, which causes the reversing pin 761 to rotate.

In some embodiments, referring to FIG. 24, the handle 721 defines a second bore 723 therein, which is open at the end of the handle 721 away from the driving mechanism 720. An end cover 7231 is provided at the opening to close the second bore 723. The second bore 723 may be used for storage of spare bits 7232.

### Embodiment VIII

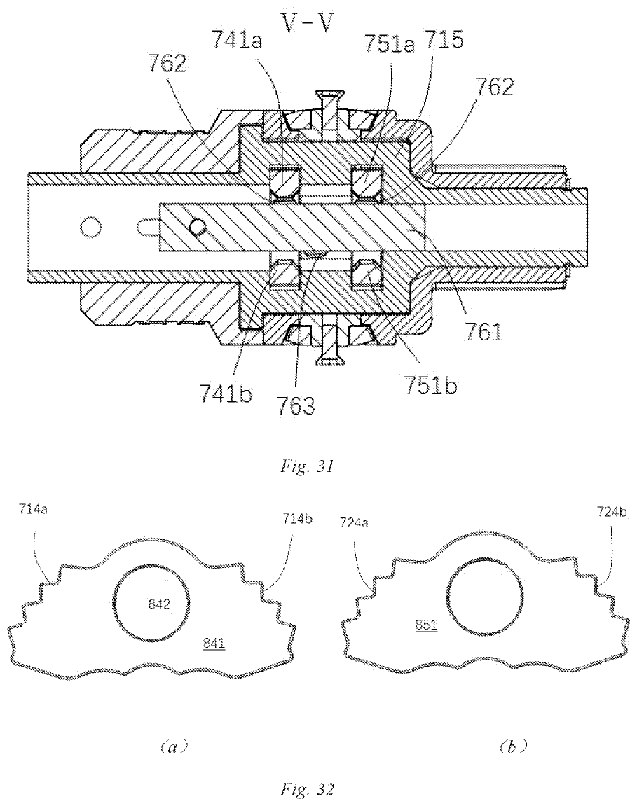

FIGS. 32 to 36 show Embodiment VIII. This embodiment is essentially similar to Embodiment VII, except only that the two pawls in each pawl compartment are provided a single pawl member. Specifically, as shown in FIG. 32, the pawls 714a and 714b are provided on a pawl member 841, and the pawls 724a and 724b are provided on a pawl member 851. The pawl members 841 and 851 are of the same structure and rotatable about an auxiliary shaft 840. The auxiliary shaft 840 is parallel to the reversing element 715 but has a center axis which does not coincide with the center axis of the reversing element 715. Only the pawl member 841 is described below as an example. The pawls 714a and 714b are located on opposite sides of the pawl member 841 which defines a central through hole 842. The auxiliary shaft 840 may be passed through the through hole 842 and mounted to the reversing element 715, enabling the pawl member 841 to swing about the auxiliary shaft 840. When the pawl member 841 swings clockwise, the pawl 714a will protrude out of the first pawl compartment 716 from its opening and intermesh with the corresponding inner ratchet circumference 7111, while the pawl 714b will be separate from the inner ratchet circumference 7111. When the pawl member 841 swings counterclockwise, the pawl 714b will protrude out of the first pawl compartment 716 from its opening and intermesh with the corresponding inner ratchet circumference 7111, while the pawl 714b will be separate from the inner ratchet circumference 7111. The pawl member 851 has the same arrangement and is able to swing about the auxiliary shaft 840 to cause the pawls 724a and 724b to intermesh with the inner ratchet circumference 7181 of the capstan gear 718.

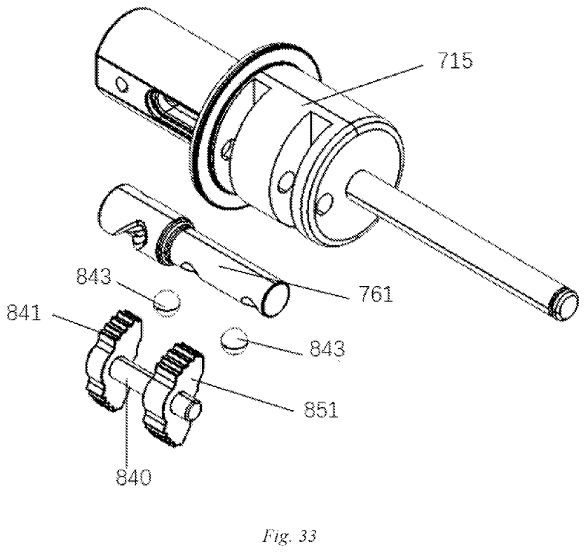

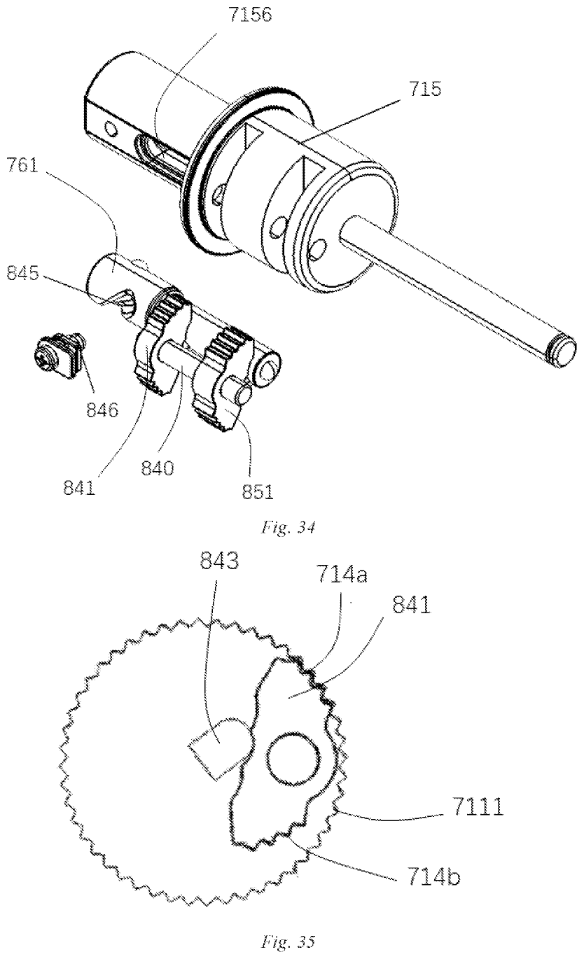

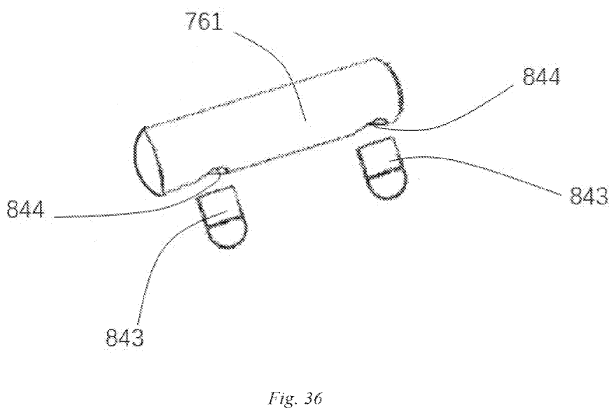

The driving members on the reversing pin 761 may be similar to the studs shown in FIG. 27, or replaced with driving components 843. The driving components 843 may be chosen as balls (FIG. 33), cylinders, ball-ended plungers (FIG. 36) or similar components. Specifically, the reversing pin 761 defines two holes 844 corresponding to the respective pawl members 841 and 851. Each of the holes 844 receives a respective one of the driving components 843. Preferably, elastic members (not shown) are provided between the driving components 843 and the bottom of the respective holes 844. The holes 844 may be blind holes, or through holes radially extending through the reversing pin 761. When the reversing pin 761 is rotated to a first or second position, the driving components 843 will come in contact with one side of the pawl members 841, 851 and push the corresponding pawls out of the pawl compartments from their opening and cause them to intermesh with the corresponding inner ratchet circumferences. At the same time, the pawls on the other side of the pawl members are separate from the inner ratchet circumferences. For example, as shown in FIG. 34, when the reversing pin 761 is rotated to the first position, the driving components 843 come in contact respectively with the side of the pawl member 841 proximate the pawl 714a and the side of the pawl member 851 proximate the pawl 724a and push the pawls 714a, 724a out of the pawl compartments and cause them to intermesh with the corresponding inner ratchet circumferences 7111, 7181. At the same time, the other pawl 714b on the pawl member 841 and the other pawl 724b on the pawl member 851 are separate from the corresponding inner ratchet circumference 71111, 7181.

A spatial cam mechanism similar to that shown in FIG. 7 may be used to enable rotation of the reversing pin 761, except that, in contrast to the spatial cam mechanism of FIG. 7 that is provided on the main shaft, the spatial cam mechanism of this embodiment is disposed on the reversing pin 761. As shown in FIG. 35, a helical sliding slot 845 may be provided in an end portion of the reversing pin 761 away from the pawls, and a transverse slot 7156 may be provided in the reversing element 715.

The chuck 708 may have a portion passing through the transverse slot 7156 into the sliding slot 845, such as an arm 846 or a steel ball. This arrangement allows axial linear movement of the chuck 708 to be converted into circular movement of the reversing pin 761, which causes the reversing pin 761 to rotate. As a result of the rotation of the reversing pin 761, the corresponding balls or cylinders 843 abuts against one side of the pawl members 741 and 751, causing the corresponding pawls to protrude out of the pawl compartments from their openings and intermesh with the inner ratchet circumferences.

Preferred specific embodiments of the present invention have been described in detail above. It is to be understood that, those of ordinary skill in the art can make various modifications and changes based on the concept of the present invention without exerting any creative effort. Accordingly, all the technical solutions that can be obtained by those skilled in the art by logical analysis, inference or limited experimentation in accordance with the concept of the present invention on the basis of the prior art are intended to fall within the protection scope as defined by the claims.

1. A screwdriver, characterized in comprising:
a handle;
a main shaft;
a driving mechanism, one end of the main shaft fixedly coupled to the driving mechanism, one end of the handle fixedly coupled to the driving mechanism,
wherein the driving mechanism comprises a driving means and a reversing means, which are coupled to each other, the driving means comprising a capstan gear, a follower gear, a transmission seat and at least one idle gear; the transmission seat provided thereon with at least one idle gear axle; the idle gear mounted on the respective idle gear axle, the idle gear cooperating with the capstan gear and the follower gear to serve for power transmission therebetween; wherein the handle used for input of a torque, one end of the capstan gear fixedly coupled to the handle, the handle configured to drive the capstan gear to rotate, the capstan gear driving the follower gear to rotate oppositely via the idle gear,
wherein the reversing means comprises a reversing element, and a first one-way clutch and a second one-way clutch which are mounted on the reversing element;
the driving means sleeved on the reversing element; the first one-way clutch in engagement with the capstan gear, the second one-way clutch in engagement with the follower gear; one end of the reversing element fixedly coupled to the main shaft, the reversing element configured to drive the main shaft to rotate therewith; as a result of the torque input from the handle, one of the capstan gear and the follower gear driving the reversing element and the main shaft to rotate in a predetermined direction;
wherein regardless of the torque input from the handle in the same or opposite direction to the predetermined direction, the main shaft always rotate in the predetermined direction;
wherein the reversing means is configured to be able to alter the predetermined direction.

2. The screwdriver of claim 1, wherein the capstan gear, the follower gear and the idle gear are all bevel gears.

3. The screwdriver of claim 1, wherein the capstan gear is provided on its inner surface with a ratchet circumference; the follower gear is provided on its inner surface with a ratchet circumference; the reversing element is provided therein with a first pawl compartment and a second pawl compartment; the first one-way clutch comprises two swinging pawls provided in the first pawl compartment; the ratchet circumference of the follower gear is configured to intermesh with at least one of the two pawls in the first pawl compartment; the second one-way clutch comprises two swinging pawls provided in the second pawl compartment; the ratchet circumference of the capstan gear is configured to intermesh with at least one of the two pawls in the second pawl compartment.

4. The screwdriver of claim 3, wherein the two pawls in the first pawl compartment are respectively formed on a first pawl member and a second pawl member; the two pawls in the second pawl compartment are respectively formed on a third pawl member and a fourth pawl member.

5. The screwdriver of claim 4, wherein the first pawl member and the third pawl member are sleeved on a first auxiliary shaft and configured to swing about the first auxiliary shaft; the second pawl member and the fourth pawl member are sleeved on a second auxiliary shaft and configured to swing about the second auxiliary shaft; the first auxiliary shaft and the second auxiliary shaft are mounted on the reversing element.

6. The screwdriver of claim 4, wherein a first elastic element is provided between the first pawl member and the second pawl member; a second elastic element is provided between the third pawl member and the fourth pawl member.

7. The screwdriver of claim 4, wherein the reversing means further comprises a reversing pin and a chuck, the reversing element provided therein a bore for receiving the reversing pin, the reversing pin disposed in the bore, the chuck coupled to the reversing pin, the chuck configured to be driven by an external force to drive the reversing pin to move therewith, wherein when the reversing pin moves to a first position, the pawl on the first pawl member protrudes out of the first pawl compartment and intermeshes with the ratchet circumference of the follower gear, and the pawl on the third pawl member protrudes out of the second pawl compartment and intermeshes with the ratchet circumference of the capstan gear; when the reversing pin moves to a second position, the pawl on the second pawl member protrudes out of the first pawl compartment and intermeshes with the ratchet circumference of the follower gear, and the pawl on the fourth pawl member protrudes out of the second pawl compartment and intermeshes with the ratchet circumference of the capstan gear.

8. The screwdriver of claim 7, wherein the chuck is sleeved on the reversing element; the reversing element is provided with a transverse slot in its side wall corresponding to the chuck; the chuck is coupled to the reversing pin by a coupling member.

9. The screwdriver of claim 8, wherein the coupling member is a pin passing through the transverse slot, one end of the pin coupled to the reversing pin, the other end coupled to the chuck; the chuck is configured to drive the reversing pin to move along its axis;
the reversing pin is provided, along its lengthwise direction, with first studs on one side and second studs on the opposing side; when the reversing pin moves to the first position, the second studs come in contact with the second pawl member and the fourth pawl member; when the reversing pin moves to the second position, the first studs come in contact with the first pawl member and the third pawl member.

10. The screwdriver of claim 3, wherein the two pawls in the first pawl compartment are formed on opposing sides of a first pawl member; the two pawls in the second pawl compartment are formed on opposing sides of a second pawl member.

11. The screwdriver of claim 10, wherein the first pawl member and the second pawl member are sleeved on an auxiliary shaft and configured to swing about the auxiliary shaft.

12. The screwdriver of claim 11, wherein the reversing means further comprises a reversing pin and a chuck, the reversing element provided therein a bore for receiving the reversing pin, the reversing pin disposed in the bore, the chuck coupled to the reversing pin, the chuck configured to be driven by an external force to drive the reversing pin to move therewith, wherein when the reversing pin moves to a first position, the reversing pin drives the first pawl member and the second pawl member to swing about the auxiliary shaft, causing the pawl on one side of the first pawl member to protrude out of the first pawl compartment and intermesh with the ratchet circumference of the follower gear and causing the pawl on the same side of the second pawl member as the first pawl member to protrude out of the second pawl compartment and intermesh with the ratchet circumference of the capstan gear; when the reversing pin moves to a second position, the reversing pin drives the first pawl member and the second pawl member to swing about the auxiliary shaft, causing the pawl on the other side of the first pawl member to protrude out of the first pawl compartment and intermesh with the ratchet circumference of the follower gear and causing the pawl on the same side of the second pawl member as the first pawl member to protrude out of the second pawl compartment and intermesh with the ratchet circumference of the capstan gear.

13. The screwdriver of claim 12, wherein the reversing pin is provided therein with holes respectively corresponding to the first pawl member and the second pawl member, the holes provided therein with driving components configured to come in contact with the first pawl member and the second pawl member.

14. The screwdriver of claim 13, wherein the driving components are balls, cylinders or ball-ended plungers.

15. The screwdriver of claim 1, wherein the screwdriver further comprises a holding ring, the holding ring is sleeved on the driving means, the holding ring fixedly coupled to the transmission seat.

16. The screwdriver of claim 1, wherein the handle defines a second bore having an opening at an end of the handle away from the driving means; an end cover for closing the second bore is disposed at the opening; the second bore is configured to be used to accommodate spare bits.

17. A screwdriver, comprising:
a handle;
a main shaft;
a reversing element, which is fixedly coupled at one end to the main shaft and configured to drive the main shaft to rotate;
a follower gear, a capstan gear, a transmission seat and at least one idle gear, the follower gear, the transmission seat and the capstan gear sleeved on the reversing element in sequence; the transmission seat provided thereon with at least one idle gear axle, the at least one idle gear mounted on the respective idle gear axle so that the idle gear be located between the follower gear and the capstan gear to serve for power transmission; one end of the capstan gear fixedly coupled to the handle, the handle configured for input of a torque for causing the capstan gear to rotate so that the capstan gear drives the follower gear rotate oppositely via the idle gear;
a holding ring, which is sleeved on the transmission seat and fixedly coupled to the transmission seat,
the reversing element provided with a first pawl compartment in its portion corresponding to the follower gear and a second pawl compartment in its portion corresponding to the capstan gear, the first pawl compartment provided therein with a first pawl and a second pawl, which can swing; the follower gear provided on its inner circumferential surface with an inner ratchet circumference, the inner ratchet circumference intermeshing with the first pawl or the second pawl; the second pawl compartment therein with a third pawl and a fourth pawl, which can swing; the capstan gear provided on its inner circumferential surface with an inner ratchet circumference, the inner ratchet circumference intermeshing with the third pawl or the fourth pawl; the first pawl and the third pawl located on the same side, the second pawl and the fourth pawl located on an opposing other side; wherein when the first pawl intermeshes with the inner ratchet circumference of the follower gear and when the third pawl intermeshes with the inner ratchet circumference of the capstan gear, irrespective of the torque input from the handle in a first direction or in a second direction, the reversing element always drives the main shaft to rotate in the first direction; when the second pawl intermeshes with the inner ratchet circumference of the follower gear and when the fourth pawl intermeshes with the inner ratchet circumference of the capstan gear, irrespective of the torque input from the handle in the first direction or in the second direction, the reversing element always drives the main shaft to rotate in the second direction, where the first direction and the second direction are opposite directions,
the reversing element also provided therein with a reversing pin, the reversing element provided with a chuck disposed thereover, the reversing element provided in its position corresponding to the chuck with a transverse slot, through which a coupling member is passed; one end of the coupling member coupled to the reversing pin, the other end coupled to the chuck, the chuck configured to be driven by an external force to drive the reversing pin to move,
the reversing pin provided thereon with driving members for driving the pawls to move; by switching positions of the reversing pin, the driving members driving the respective pawls to move; wherein when the reversing pin moves to a first position, the first pawl protrudes out of the first pawl compartment and intermeshes with the inner ratchet circumference of the follower gear and the third pawl protrudes out of the second pawl compartment and intermeshes with the inner ratchet circumference of the capstan gear, enabling the main shaft to rotate, when driven, always in the second direction; when the reversing pin moves to a second position, the second pawl protrudes out of the first pawl compartment and intermeshes with the inner ratchet circumference of the follower gear and the fourth pawl protrudes out of the second pawl compartment and intermeshes the inner ratchet circumference of the capstan gear, enabling the main shaft to rotate, when driven, always in the first direction.

18. The screwdriver of claim 17, wherein the first pawl compartment is provided therein with a first pawl member and a second pawl member; the first pawl is formed on the first pawl member; the second pawl is formed on the second pawl member; the second pawl compartment is provided therein with a third pawl member and a fourth pawl member; the third pawl is formed on the third pawl member; the fourth pawl is formed on the fourth pawl member; the first pawl member and the third pawl member are sleeved on a first auxiliary shaft and configured to swing about the first auxiliary shaft; the second pawl member and the fourth pawl member are sleeved on a second auxiliary shaft and configured to swing about the second auxiliary shaft; the first auxiliary shaft and the second auxiliary shaft are mounted on the reversing element; a first elastic element is provided between the first pawl member and the second pawl member; a second elastic element is provided between the third pawl member and the fourth pawl member.

19. The screwdriver of claim 18, wherein the driving member includes first studs and second studs, wherein the first studs are provided on a side of the reversing pin oriented toward the first pawl member and the third pawl member; the second studs are provided on a side of the reversing pin oriented toward the second pawl member and the fourth pawl member; when the reversing pin moves to the first position, the first studs come in contact with the first pawl member and the third pawl member; when the reversing pin moves to the second position, the second studs come in contact with the second pawl member and the fourth pawl member.

20. The screwdriver of claim 19, wherein the coupling member is a pin passing through the transverse slot, one end of the pin coupled to the reversing pin, the other end coupled to the chuck; the chuck is configured to drive the reversing pin to move along its axis.
